(19) United States
(12) Patent Application Publication
(10) Pub. No.: US 2011/0205654 A1
(43) Pub. Date: Aug. 25, 2011

(54) CONTROL APPARATUS, NONVOLATILE STORAGE APPARATUS AND DATA INITIALIZATION METHOD

(75) Inventor: Hiroshi SAKURAI, Kawasaki (JP)

(73) Assignee: FUJITSU LIMITED, Kawasaki-shi (JP)

(21) Appl. No.: 13/019,594

(22) Filed: Feb. 2, 2011

(30) Foreign Application Priority Data
Feb. 22, 2010 (JP) 2010-036689

(51) Int. Cl. G11B 27/36

(52) U.S. Cl. 360/31; 360/53; G9B/27.052

(57) ABSTRACT

A control apparatus for controlling initialization of data stored in a storage unit in response to receipt of an initialization instruction from a host system, includes (a) a register unit that stores inversion bit information indicating a plurality of bits to be inverted in data readout process, (b) a data receiving unit that receives read data and an error correcting code corresponding to the read data, and (c) an inversion unit that inverts part of bits of at least one of the read data and the error correcting code corresponding to the read data on the basis of the inversion bit information in the data readout process after the receipt of the initialization instruction. In the above (a), the plurality of bits to be inverted being part of bits of at least one of read data and an error correcting code corresponding to the read data.

### CROSS-REFERENCE TO RELATED APPLICATION

This application is based upon and claims the benefit of priority of the prior Japanese Patent Application No. 2010-036689, filed on Feb. 22, 2010, the entire contents of which are incorporated herein by reference.

### FIELD

The embodiments discussed herein relates to a technology to initialize data in a storage medium.

### BACKGROUND

Storage media used in server systems, Redundant Arrays of Inexpensive Disks (RAID) systems, etc. have increased in capacity. In reuse of the storage media that have been used in server systems, etc., it is necessary to initialize the storage media, by to writing “0” in the entire area of the storage media, for example, in order to prevent malfunction of the systems.

However, it takes a lot of time to write “0” in the entire area of the storage media to perform the initialization because of the increased capacity of the storage media. Accordingly, there is a problem in that it is not possible to rapidly perform the reuse of the storage media.

A technology to initialize data in a storage medium is disclosed in Japanese Laid-open Patent Publication No. 57-152575.

### SUMMARY

According to an aspect of the embodiments, a control apparatus for controlling initialization of data stored in a storage unit in response to receipt of an initialization instruction from a host system, includes a register unit that stores inversion bit information indicating a plurality of bits to be inverted in data readout process, the plurality of bits to be inverted in data readout process being part of bits of at least one of read data that is read from the storage unit and an error correcting code corresponding to the read data, a data receiving unit that receives the read data and the error correcting code corresponding to the read data, the read data and the error correcting code corresponding to the read data being read from the storage unit, and an inversion unit that inverts part of bits of at least one of the read data and the error correcting code corresponding to the read data on the basis of the inversion bit information in the data readout process after the receipt of the initialization instruction.

The object and advantages of the embodiment will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram showing an example of the configuration of a hard disk apparatus according to a first embodiment;

FIG. 2 is a block diagram showing an example of the configuration of the hard disk apparatus according to the first embodiment, in which the configuration of a hard disk controller is illustrated in detail;

FIG. 3 schematically illustrates readout of data from a medium according to the first embodiment;

FIG. 4 schematically illustrates writing of data on the medium according to the first embodiment;

FIG. 5 is a flowchart showing an example of a process of inverting bits in ECC data according to the first embodiment;

FIG. 6 is a flowchart showing an example of a data readout process according to the first embodiment;

FIG. 7 is a flowchart showing an example of a data writing process according to the first embodiment;

FIG. 8 is a block diagram showing an example of the configuration of a hard disk apparatus according to a second embodiment, in which the configuration of a hard disk controller is illustrated in detail;

FIG. 9 schematically illustrates readout of data from a medium according to the second embodiment;

FIG. 10 schematically illustrates writing of data on the medium according to the second embodiment;

FIG. 11 is a flowchart showing an example of a process of inverting bits in data according to the second embodiment;

FIG. 12 is a flowchart showing an example of a data readout process according to the second embodiment;

FIG. 13 is a flowchart showing an example of a data writing process according to the second embodiment;

FIG. 14 is a block diagram showing an example of the configuration of a hard disk apparatus according to a third embodiment, in which the configuration of a hard disk controller is illustrated in detail;

FIG. 15 schematically illustrates readout of data from a medium according to the third embodiment;

FIG. 16 schematically illustrates writing of data on the medium according to the third embodiment;

FIG. 17 is a flowchart showing an example of a process of inverting bits in data according to the third embodiment;

FIG. 18 is a flowchart showing an example of a data readout process according to the third embodiment; and

FIG. 19 is a flowchart showing an example of a data writing process according to the third embodiment.

### DESCRIPTION OF EMBODIMENTS

Embodiments will herein be described with reference to the attached drawings by taking a hard disk (HDD) representative of a storage medium as an example.

### Embodiments

### First Embodiment

[1.1. Hard Disk Apparatus 100]

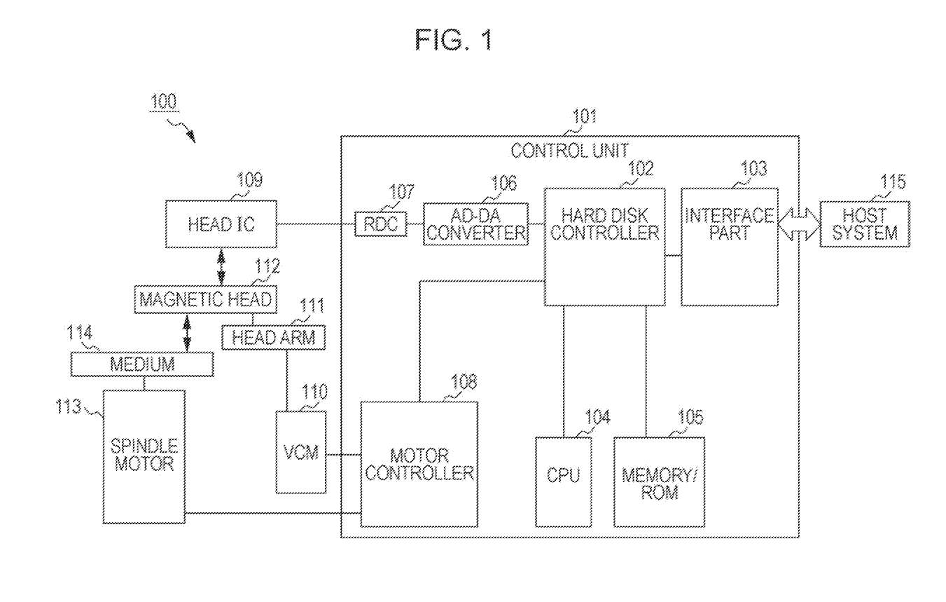

FIG. 1 is a block diagram showing an example of the configuration of a hard disk apparatus 100 according to a first embodiment of the present invention. Referring to FIG. 1, the hard disk apparatus 100 is connected to a host system 115 and is a storage medium capable of writing and reading out data. The host system 115 is connected to an input apparatus, a display apparatus, and so on including the hard disk apparatus 100 and controls the entire system. According to the first embodiment, the host system 115 is, for example, a RAID controller in a RAID apparatus. When the host system 115 is a RAID controller, the host system 115 manages the hard disk apparatus 100 on the basis of, for example, whether the hard disk apparatus 100 is a master disk or a slave disk by using a system area provided in the storage region in the hard disk apparatus 100. Accordingly, it is necessary to set the hard disk apparatus 100 to an initialization state to connect the hard disk apparatus 100 to the host system 115. In other words, when data is written into the hard disk apparatus 100 before the hard disk apparatus 100 is connected to a RAID apparatus, it is necessary to connect the hard disk apparatus 100 that has been initialized to the RAID apparatus. This is because the entire system can possibly malfunction if the hard disk apparatus 100 is connected to, for example, a RAID apparatus in a state in which data is written into the system area in the hard disk apparatus 100. The hard disk apparatus 100 according to the first embodiment is capable of performing a high-speed data initialization process, and it is possible to prevent malfunction of the system in reuse of the hard disk apparatus 100. The configuration of the hard disk apparatus 100 and the data initialization process in the hard disk apparatus 100 will now be described.

The hard disk apparatus 100 includes a control unit 101, a head IC 109, a voice coil motor (VCM) 110, a head arm 111, a magnetic head 112, a spindle motor 113, and a medium 114. The control unit 101 is a example of a control apparatus. The hard disk apparatus 100 controls writing and readout of data on the basis of an instruction from the host system 115.

In writing data into the hard disk apparatus 100, the host system 115 supplies a write command and write data to be written into the medium to the control unit 101 through an interface part 103. A central processing unit (CPU) 104 controls the voice coil motor 110 and the spindle motor 113 via a motor controller 108. The motor controller 108 controls the voice coil motor 110 to control the position of the magnetic head 112. The control unit 101 moves the magnetic head 112 to a desired track position on the medium 114 via the head arm 111. The motor controller 108 controls the spindle motor 113 to rotate the medium 114 at a rated speed. A hard disk controller 102 supplies the write data to a read channel (RDC) 107 through an analog to digital-digital to analog (AD-DA) converter 106. The read channel 107 encodes the write data to supply the encoded write data to the head IC 109. The head IC 109 supplies the encoded write data to the magnetic head 112 that writes the write data on the medium 114. The rated speed means a speed of rotation of the medium 114, at which the hard disk apparatus 100 can offer the proper performance under predetermined normal working conditions, for example, at about one atmosphere and at room temperature.

In reading data from the hard disk apparatus 100, the host system 115 supplies a read command (a read instruction) to the control unit 101 through the interface part 103. The hard disk controller 102 supplies the read command to the CPU 104. The CPU 104 analyzes the received read command and notifies the hard disk controller 102 of information about the position of the medium from which the data is read out to control the voice coil motor 110 and the spindle motor 113 via the motor controller 108. The control unit 101 moves the magnetic head 112 to a desired track position on the medium 114 via the head arm 111. The motor controller 108 controls the voice coil motor 110 to control the position of the magnetic head 112. The motor controller 108 controls the spindle motor 113 to rotate the medium 114 at the rated speed. The magnetic head 112 reads out data from the medium 114, and the data is supplied to the read channel 107 through the head IC 109. The read channel 107 decodes the readout data to generate read data. The read channel 107 supplies the read data to the hard disk controller 102 through the AD-DA converter 106. The hard disk controller 102 supplies the read data to the host system 115 through the interface part 103.

[1.2. Control Unit 101]

The control unit 101 includes the hard disk controller 102, the interface part 103, the CPU 104, a memory/read only memory (ROM) 105, the AD-DA converter 106, the read channel 107, and the motor controller 108. The host system 115 is connected to the hard disk controller 102 in the control unit 101 via the interface part 103. The interface part 103 is capable of data communication according to Serial Advanced Technology Attachment (SATA) or Serial Attached Small Computer System Interface (SCSI) (SAS). The memory/ROM 105 stores programs, etc. necessary to control the operation of the hard disk apparatus 100. The CPU 104 reads out a program, etc. from the memory/ROM 105 to control the operation of the hard disk apparatus 100 via the hard disk controller 102. The memory/ROM 105 has an area into which data can be written and from which part of the data can be deleted. The data to be written on the medium 114, which is received from the host system 115, can be stored in the area.

[1.3. Hard Disk Controller 102]

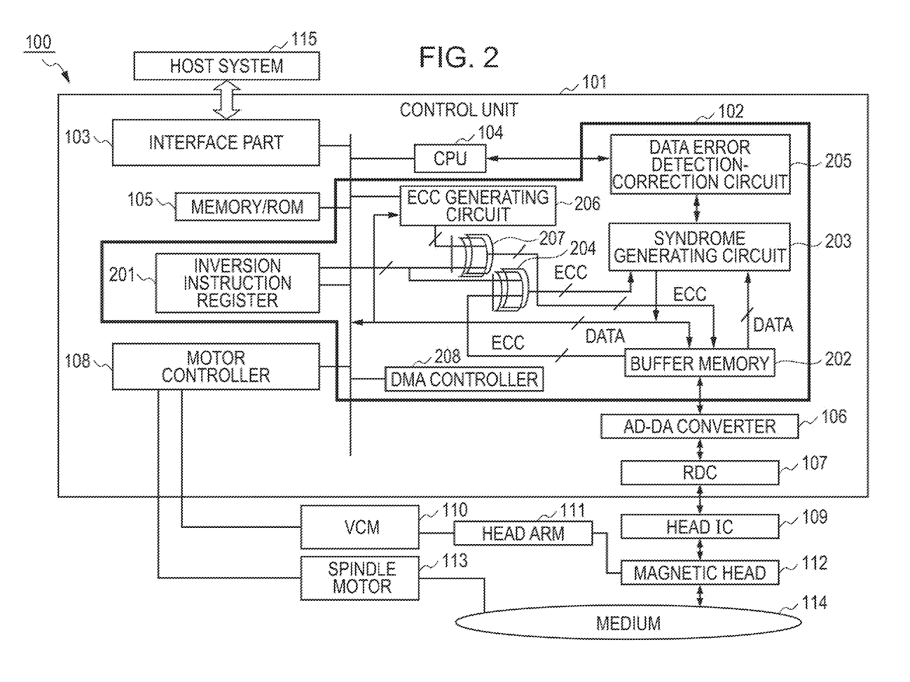

FIG. 2 is a block diagram showing an example of the configuration of the hard disk apparatus 100, in which the configuration of the hard disk controller 102 in the control unit 101 is illustrated in detail. The hard disk controller 102 according to the first embodiment includes an inversion instruction register 201, a buffer memory 202, a syndrome generating circuit 203, an inverter circuit 204, a data error detection-correction circuit 205, an Error Correcting Code (ECC) generating circuit 206, an inverter circuit 207, and a Direct Memory Access (DMA) controller 208.

The DMA controller 208 controls transfer of data in the hard disk controller 102 without depending on the CPU 104. The ECC data generating circuit 206 generates ECC data to be attached to the data. The syndrome generating circuit 203 uses the data and the ECC data attached to the data to generate an ECC syndrome (hereinafter simply referred to as a syndrome). The data to which the ECC data is attached is stored in the medium 114 in order to improve the reliability of the hard disk apparatus 100. The hard disk apparatus 100 can perform data correction with the ECC data even if a data error, such as corruption of the data, occurs. The data error detection-correction circuit 205 refers to the syndrome to detect and correct the data error. The syndrome generating circuit 203 has a function of an error determination unit.

The hard disk controller 102 according to the first embodiment uses the inversion instruction register 201, the inverter circuit 204, and the inverter circuit 207 to initialize data. The hard disk controller 102 inverts part of the bits of the ECC data attached to the data to invalidate the data. The hard disk controller 102 initializes the data by invalidating the data. According to the first embodiment, the data has 64 bits and the ECC data attached to 64-bit data has eight bits. The inversion instruction register 201 stores inversion bit information for identifying two bits among the eight bits composing the ECC data to be inverted.

When the hard disk controller 102 initializes data and reads out the data from the medium 114, the inverter circuit 204 reads out ECC data and specific information in the inversion instruction register 201 for identifying two bits in the read ECC data to be inverted from the buffer memory 202 to invert the specific two bits in the ECC data. The inverter circuit 204 inverts the specific two bits in the ECC data to generate inverted ECC data. The syndrome generating circuit 203 uses the inverted ECC data and the corresponding data to generate a syndrome. The data error detection-correction circuit 205 determines that the data is uncorrectable because of the two-bit error from the syndrome and, thus, determines that the data is invalid. Consequently, the hard disk controller 102 performs the initialization.

When the hard disk controller 102 initializes data and writes the data on the medium 114, the inverter circuit 207 reads out ECC data generated from data to be written by the ECC data generating circuit 206 and specific information in the inversion instruction register 201 identifying two bits in ECC data to be inverted to invert the specific two bits in the ECC data. The inverter circuit 207 inverts the specific two bits in the ECC data to generate inverted ECC data. The specific two bits in the ECC data inverted by the inverter circuit 207 are the same as the specific two bits in ECC data that the inverter circuit 204 inverts. The inverter circuit 207 stores the inverted ECC data in the buffer memory 202. Data corresponding to the inverted ECC data is also stored in the buffer memory 202. The data is supplied from the memory/ROM 105 to the buffer memory 202 under the control of the CPU 104. The magnetic head 112 writes the data and the inverted ECC data corresponding to the data on the medium 114. When data is read out from the medium 114, the inverter circuit 204 generates the inverted ECC data. Accordingly, after initialization has been performed in the reading of the data, the data that is written on the medium 114 by inverting specific two bits in the ECC data can be successfully read out from the medium 114.

Although the inverter circuits 204 and 207 invert two bits in ECC data to invalidate the data in the first embodiment, the inversion method is not limited to the above one. Multiple bits in the ECC data may be inverted so that the data error detection-correction circuit 205 cannot perform the data error correction. In other words, the number of bits to be inverted in the ECC data is required to be more than a number of bits of which the ECC can correct the error, and may be three or more.

The number of patterns of inversion that make the data error uncorrectable in the error correction is equal to the number of combinations that are different from each other in the bits to be inverted, in which the number of bits overlapping between any two of the combinations is not two or more, and corresponds to the number of times the data initialization process according to the first embodiment can be performed.

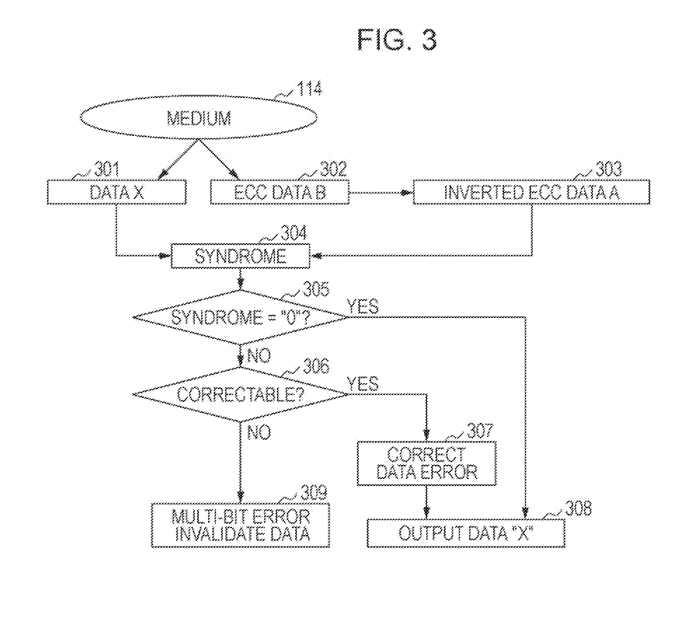

FIG. 3 schematically illustrates an example of an operation of data initialization and read out of data from the medium 114 according to the first embodiment. Readout of data according to the first embodiment will now be described with reference to FIG. 3.

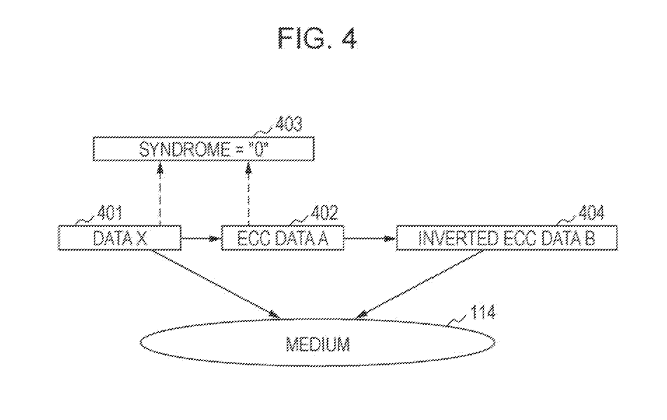

Referring to FIG. 3, in Step 301, the magnetic head 112 reads out data X from the medium. In Step 302, the magnetic head 112 reads out ECC data B corresponding to the data X from the medium. In Step 303, the inverter circuit 204 inverts specific two bits in the ECC data B to generate inverted ECC data A. The ECC data B passed through the inverter circuit 207 (Step 404 in FIG. 4) in the previous writing of data. In Step 304, the syndrome generating circuit 203 uses the data X and the inverted ECC data A to generate a syndrome, in which all the bits are set to zero when it is normal. In Step 305, the data error detection-correction circuit 205 determines whether all the bits in the syndrome are zero. If the data error detection-correction circuit 205 determines that all the bits in the syndrome are zero (YES in Step 305), in Step 308, the CPU 104 supplies the data X to the host system 115 through the interface part 103. If the data error detection-correction circuit 205 determines that at least one of all the bits in the syndrome are not zero (NO in Step 305), in Step 306, the data error detection-correction circuit 205 detects that an error occurs in the data, and determines whether the syndrome indicates a correctable data error, such as a single-bit error. If the data error detected by the data error detection-correction circuit 205 is correctable (YES in Step 306), in Step 307, the data error detection-correction circuit 205 corrects the data error. In Step 308, the CPU 104 supplies the data X in which the error is corrected in Step 307 to the host system 115 through the interface part 103. If the data error detected by the data error detection-correction circuit 205 is not correctable (NO in Step 306), in Step 309, the CPU 104 determines that the data error is a multi-bit error and that the data is invalid.

FIG. 4 schematically illustrates an example of an operation of the data initialization and writing of data on the medium 114 according to the first embodiment. Writing of data according to the first embodiment will now be described with reference to FIG. 4.

In the writing of data on the medium 114, in Steps 401 and 402, the ECC data generating circuit 206 generates ECC data A from data X to be written to the medium. In Step 403, the syndrome generating circuit 203 receives the data X and the generated ECC data A to generate a syndrome which is normal when all the bits are set to zero. In Step 404, the inverter circuit 207 generates inverted ECC data B from the ECC data A. Then, the magnetic head 112 writes the data X and the inverted ECC data B on the medium 114.

[1.4. Process of Inverting Bits in ECC Data]

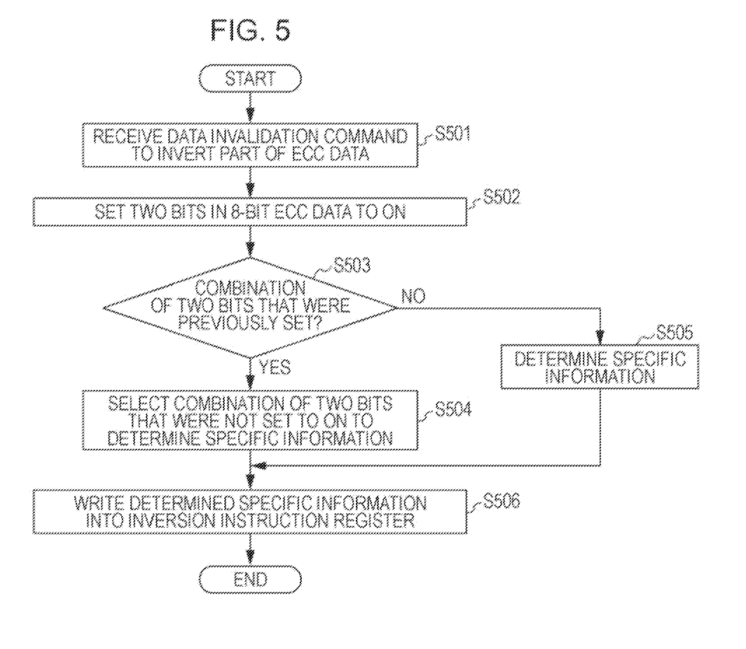

FIG. 5 is a flowchart showing an example of a process of inverting bits in ECC data according to the first embodiment. Referring to FIG. 5, in Step S501, the control unit 101 receives a data invalidation command to invalidate data by inverting part of ECC data from the host system 115. In Step S502, the hard disk controller 102 sets two bits in the ECC data to ON. According to the first embodiment, the length of data is 64 bits and the length of ECC data corresponding to the data is eight bits. CPU 104 of the hard disk controller 102 sets two bits in the eights-bit ECC data to ON. Setting the bits to ON means a selection of candidates for bits in the ECC data to be inverted. In Step S503, the CPU 104 determines whether the combination of two bits that are set to ON coincides with a combination of two bits that were set to ON for the past data initialization. If the combination of two bits that are set to ON by the CPU 104 does not coincide with the combination of two bits that were set to ON in the past (NO in Step S503), in Step S505, the CPU 104 selects the two bits set to ON in Step S502 and thereby determines specific information used for generating inverted ECC data. In Step S506, the CPU 104 writes the determined specific information into the inversion instruction register 201. If the combination of two bits that are set to ON by the CPU 104 coincides with the combination of two bits that were set to ON in the past (YES in Step S503), in Step S504, the CPU 104 selects a combination of two bits in the ECC data which were not previously set to ON to determine specific information. In Step S506, the CPU 104 writes the determined specific information into the inversion instruction register 201. CPU 104 has a function of an inversion bit control unit.

The specific information identifies two bits in the ECC data to be inverted and is composed of eight bits. Bits in the specific information which identify two bits in the ECC data to be inverted are set to “one.” Writing the specific information into the inversion instruction register 201 means writing the data in which at least one of all the bits are not set to zero and the two bits in the eight bits are set to “one” into the inversion instruction register 201.

The inversion instruction register 201 also stores the specific information that was written to initialize data in the past and that was used in the past data initialization as a history. The inversion instruction register 201 also has a flag to identify the current specific information used for the current data initialization. Accordingly, in Step S503, the CPU 104 refers to the history of the specific information that was used for the past data initialization to determine whether the combination of the two bits set to ON coincides with the combination of the two bits that were set to ON in the past. After the CPU 104 writes the specific information into the inversion instruction register 201 in Step S506, the flag corresponding to the written specific information is set to ON. If a flag that is set to ON exists, the flag is set to OFF.

[1.5. Data Readout Process]

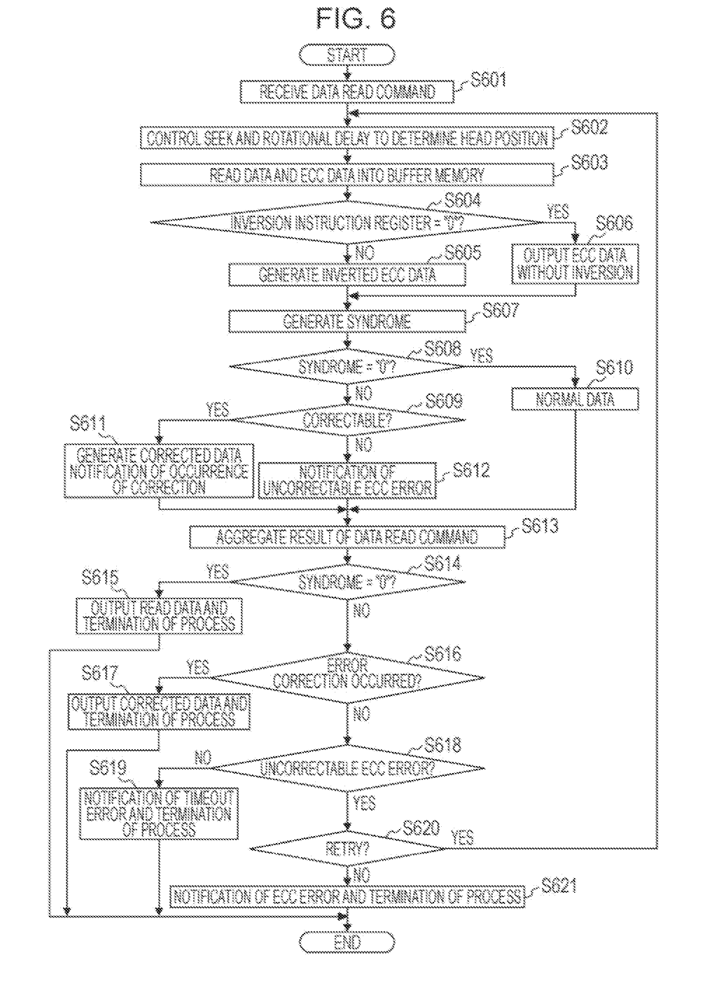

FIG. 6 is a flowchart showing an example of a data readout process according to the first embodiment.

Referring to FIG. 6, in Step S601, the control unit 101, more specifically, the CPU 104 in the control unit 101 receives a data read command from the host system 115 through the interface part 103. The data read command indicates that data at the W-th address is to be read out and instructs the control unit 101 to access the data at the W-th address in a Logical Block Addressing (LBA) mode.

In Step S602, the CPU 104 controls seek and rotational delay in order to determine the position of the magnetic head 112. After the CPU 104 controls the seek and the rotational delay of the magnetic head 112 so that the data at the W-th address can be read out, in Step S603, the magnetic head 112 reads out data and ECC data corresponding to the data from the medium into the buffer memory 202 on the basis of the control of the operation by the CPU 104. The buffer memory 202 has a function of a data receiving unit.

In Step S604, the CPU 104 determines whether specific information for generating inverted ECC data is written into the inversion instruction register 201. If the specific information is not written into the inversion instruction register 201, all the bits in the inversion instruction register are set to zero as an initial value. The fact that all the bits in the inversion instruction register 201 are set to zero is indicated by “inversion instruction register=“0”” in the flowchart indicating the data readout process in FIG. 6.

If the CPU 104 determines that no specific information is written into the inversion instruction register 201 (YES in Step S604), in Step S606, the inverter circuit 204 supplies the ECC data read out from the buffer to the syndrome generating circuit 203 without inverting any bit in the read ECC data because all the bits in the inversion instruction register are set to zero. Specifically, the inverter circuit 204 reads out the ECC data from the buffer memory 202 and also reads out the data in which all the bits are set to zero when no specific information is written from the inversion instruction register 201. The inverter circuit 204 supplies the ECC data to the syndrome generating circuit 203 without inverting any bit in the ECC data.

If the CPU 104 determines that the specific information is set in the inversion instruction register 201 (NO in Step S604), in Step S605, the inverter circuit 204 inverts specific two bits in the ECC data to generate inverted ECC data. It is necessary to set two or more bits in the inversion instruction register 201 to “1” in order to invalidate the data. Specifically, the inverter circuit 204 inverts specific two bits in the ECC data which is read out from the buffer memory 202 and in which the corresponding specific bits written into the inversion instruction register 201 are set to “1”, to generate inverted ECC data, and supplies the generated inverted ECC data to the syndrome generating circuit 203.

The syndrome generating circuit 203 receives the data and the ECC data read out from the buffer memory 202. The ECC data outputted in Step S606 or the inverted ECC data generated in Step S605 is supplied from the inverter circuit 204 to the syndrome generating circuit 203. In Step S607, the syndrome generating circuit 203 generates a syndrome from the data and the ECC data (or the inverted ECC data) corresponding to the data.

In Step S608, the data error detection-correction circuit 205 determines whether all the bits in the syndrome are set to zero. If the data error detection-correction circuit 205 determines that all the bits in the syndrome are set to zero (YES in Step S608), in Step S610, the data error detection-correction circuit 205 determines that the data is normal. If the data error detection-correction circuit 205 determines that at least one of all the bits in the syndrome are not set to zero (NO in Step S608), in Step S609, the data error detection-correction circuit 205 detects that an error occurs in the data and determines whether the syndrome indicates a correctable data error, such as a single-bit error.

If the data error detection-correction circuit 205 determines that the data error is correctable (YES in Step S609), in Step S611, the data error detection-correction circuit 205 corrects the data error to generate corrected data and notifies the CPU 104 of the occurrence of the correction. If the data error detection-correction circuit 205 determines that the data error is not correctable (NO in Step S609), in Step S612, the data error detection-correction circuit 205 notifies the CPU 104 of the uncorrectable ECC error.

In Step S613, the CPU 104 aggregates the result of the readout of the data for the data read command received from the host system 115. The control unit 101 performs the following analysis on the basis of the result of the readout of the data aggregated by the CPU 104. Then, the data readout process is terminated.

In Step S614, the control unit 101 determines whether all the bits in the syndrome generated by the syndrome generating circuit 203 are set to zero. If the control unit 101 determines that all the bits in the syndrome generated by the syndrome generating circuit 203 are set to zero (YES in Step S614), in Step S615, the control unit 101 supplies the read data to the host system 115 through the interface part 103. Then, the data readout process is terminated. If the control unit 101 determines that at least one of all the bits in the syndrome generated by the syndrome generating circuit 203 are not set to zero (NO in Step S614), in Step S616, the CPU 104 determines whether a notification that the correction of the data error occurred is received from the data error detection-correction circuit 205. If the CPU 104 determines that a notification that the correction of the data error occurred is received from the data error detection-correction circuit 205 (YES in Step S616), in Step S617, the control unit 101 supplies the corrected data to the host system 115 through the interface part 103. Then, the data readout process is terminated. If the CPU 104 determines that a notification that the correction of the data error occurred is not received from the data error detection-correction circuit 205 (NO in Step S616), in Step S618, the CPU 104 determines whether a notification that the uncorrectable ECC error occurred is received from the data error detection-correction circuit 205. If the CPU 104 determines that a notification that the uncorrectable ECC error occurred is not received from the data error detection-correction circuit 205 (NO in Step S618), in Step S619, the control unit 101 does not supply the data to the host system 115 and notifies the host system 115 of a timeout error. Then, the data readout process is terminated. If the CPU 104 determines that a notification that the uncorrectable ECC error occurred is received from the data error detection-correction circuit 205 (YES in Step S618), in Step S620, the CPU 104 determines whether to retry the readout of data. If the CPU 104 determines to retry the readout of data (YES in Step S620), the process goes back to Step S602 and the CPU 104 controls the seek and the rotational delay again in order to determine the position of the magnetic head 112. If the CPU 104 determines not to retry the readout of data (NO in Step S620), in Step S621, the CPU 104 notifies the host system 115 that the ECC error occurred in the read data through the interface part 103. Then, the data readout process is terminated.

[1.6. Data Writing Process]

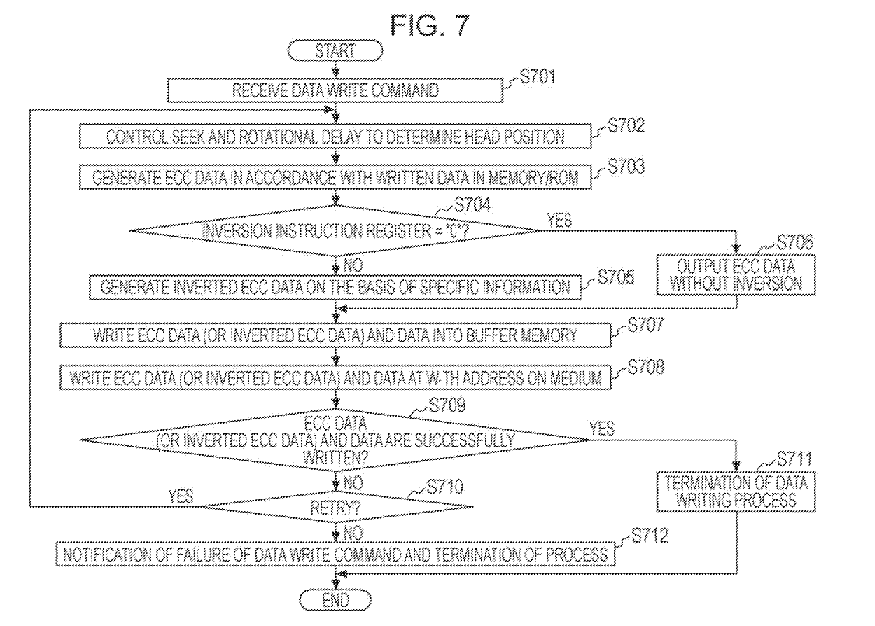

FIG. 7 is a flowchart showing an example of a data writing process according to the first embodiment.

Referring to FIG. 7, in Step S701, the control unit 101, more specifically, the CPU 104 in the control unit 101 receives a data write command from the host system 115 through the interface part 103. The data write command indicates that data is to be written at the W-th address and instructs the control unit 101 to access the data at the W-th address in the LBA mode. The control unit 101 receives write data to be written into the medium through the interface part 103 and stores the write data in the memory/ROM 105.

In Step S702, the CPU 104 controls the seek and the rotational delay in order to determine the position of the magnetic head 112. In Step S703, the ECC data generating circuit 206 reads out the write data stored in the memory/ROM 105 to generate ECC data corresponding to the write data.

In Step S704, the CPU 104 determines whether specific information for generating inverted ECC data is written into the inversion instruction register 201. If the CPU 104 determines that no specific information is written into the inversion instruction register 201 (YES in Step S704), in Step S706, the inverter circuit 207 supplies the ECC data generated in the ECC data generating circuit 206 to the buffer memory 202 without inverting the ECC data. Specifically, the ECC data is supplied from the ECC data generating circuit 206 to the inverter circuit 207. The inverter circuit 207 reads out the data in which all the bits are set to zero in a case when no specific information is written, from the inversion instruction register 201. The inverter circuit 207 supplies the ECC data to the buffer memory 202 without inverting any bit in the ECC data.

If the CPU 104 determines that the specific information is set in the inversion instruction register 201 (NO in Step S704), in Step S705, the inverter circuit 207 inverts specific two bits in the ECC data to generate inverted ECC data. Specifically, when the data that is invalidated in the readout of the data is used as valid data in the writing of the data, it is necessary to perform the writing with the inversion instruction register 201 set to the same manner as in the readout of the data. The ECC data is supplied from the ECC data generating circuit 206 to the inverter circuit 207. The inverter circuit 207 reads out the specific information written in the inversion instruction register 201. The inverter circuit 207 inverts two bits in the ECC data indicated by the specific information to generate inverted ECC data.

In Step S707, the CPU 104 writes the data stored in the memory/ROM 105 into the buffer memory 202 and the inverter circuit 207 writes the ECC data outputted in Step S706 or the inverted ECC data generated in Step S705 into the buffer memory 202. In Step S708, the CPU 104 writes the ECC data (or the inverted ECC data) and the data stored in the buffer memory 202 at the W-th address of the medium 114. Specifically, the CPU 104 accesses the W-th address of the medium 114 in the LBA mode to write the ECC data (or the inverted ECC data) and the data at the W-th address of the medium 114 through the AD-DA converter 106 and the read channel 107.

In Step S709, the CPU 104 determines whether the ECC data (or the inverted ECC data) and the data are successfully written at the W-th address of the medium 114. If the CPU 104 determines that the ECC data (or the inverted ECC data) and the data are successfully written at the W-th address of the medium 114 (YES in Step S709), in Step S711, the control unit 101 notifies the host system 115 that the data writing process is successfully performed through the interface part 103. Then, the data writing process is terminated. If the CPU 104 determines that the ECC data (or the inverted ECC data) and the data are not successfully written at the W-th address of the medium 114 (NO in Step S709), in Step S710, the CPU 104 determines whether to retry the writing of data. If the CPU 104 determines that the writing of data is retried (YES in Step S710), the process goes back to Step S702 and the CPU 104 controls the seek and the rotational delay again in order to determine the position of the magnetic head 112. If the CPU 104 determines not to retry the writing of data (NO in Step S710), in Step S712, the control unit 101 notifies the host system 115 that the data writing process is failed through the interface part 103. Then, the data writing process is terminated.

### Second Embodiment

A case in which part of the bits in data is inverted and ECC data is generated from the data before the inversion to invalidate (initialize) the data will now be described as a second embodiment of the present invention.

[2.1. Hard Disk Apparatus 800]

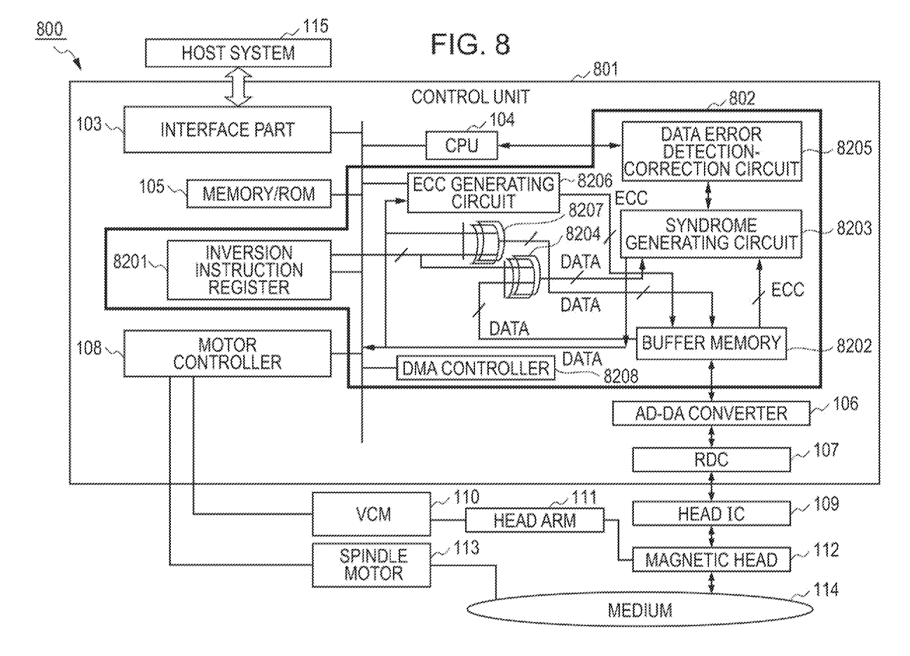

FIG. 8 is a block diagram showing an example of the configuration of a hard disk apparatus 800 according to the second embodiment. Referring to FIG. 8, the hard disk apparatus 800 is connected to a host system 115 and is a storage medium capable of writing and reading out data. The host system 115 is connected to an input apparatus, a display apparatus, and so on including the hard disk apparatus 800 and controls the entire system. According to the second embodiment, the host system 115 is, for example, a RAID apparatus. When the host system 115 is a RAID apparatus, the host system 115 manages the hard disk apparatus 800 on the basis of, for example, whether the hard disk apparatus 800 is a master disk or a slave disk by using a system area provided in the storage region in the hard disk apparatus 800. Accordingly, it is necessary to set the hard disk apparatus 800 to an initialization state to connect the hard disk apparatus 800 to the host system 115. In other words, when data is written into the hard disk apparatus 800 before the hard disk apparatus 800 is connected to a RAID apparatus, it is necessary to connect the hard disk apparatus 800 that has been initialized to the RAID apparatus. This is because the entire system can possibly malfunction because of information remaining in the system area if the hard disk apparatus 800 is connected to, for example, a RAID apparatus in a state in which data is written into the system area in the hard disk apparatus 800. In addition, in writing of data into the system area, only connecting a medium to the RAID apparatus and turning on the RAID apparatus can cause system data, such as information about the configuration of the RAID apparatus, to be written on the medium. Accordingly, it is necessary to invalidate the information when the medium that has been connected to the RAID apparatus once is used in another RAID apparatus. The hard disk apparatus 800 according to the second embodiment is capable of performing a high-speed data initialization process, and it is possible to prevent malfunction of the system in reuse of the hard disk apparatus 800. The configuration of the hard disk apparatus 800 and the data initialization process in the hard disk apparatus 800 will now be described.

The hard disk apparatus 800 includes a control unit 801, a head IC 109, a voice coil motor (VCM) 110, a head arm 111, a magnetic head 112, a spindle motor 113, and a medium 114. The control unit 801 is an example of a control apparatus The hard disk apparatus 800 controls writing and readout of data on the basis of an instruction from the host system 115.

In writing data into the hard disk apparatus 800, the host system 115 supplies a write command and write data to be written to the medium to the control unit 801 through an interface part 103. A central processing unit (CPU) 104 controls the voice coil motor 110 and the spindle motor 113 via a motor controller 108. The motor controller 108 controls the voice coil motor 110 to control the position of the magnetic head 112. The control unit 801 moves the magnetic head 112 to a desired track position on the medium 114 via the head arm 111. The motor controller 108 controls the spindle motor 113 to rotate the medium 114 at a rated speed. A hard disk controller 802 supplies the write data to a read channel (RDC) 107 through an analog to digital-digital to analog (AD-DA) converter 106. The read channel 107 encodes the write data to supply the encoded write data to the head IC 109. The head IC 109 supplies the encoded write data to the magnetic head 112 that writes the write data on the medium 114. The rated speed means a speed of rotation of the medium 114, at which the hard disk apparatus 800 can offer the proper performance under predetermined normal working conditions, for example, at about one atmosphere and at room temperature.

In reading data from the hard disk apparatus 800, the host system 115 supplies a read command (a read instruction) to the control unit 801 through the interface part 103. The hard disk controller 802 supplies the read command to the CPU 104. The CPU 104 analyzes the received read command and notifies the hard disk controller 802 of information about the position of the medium from which the data is read out to control the voice coil motor 110 and the spindle motor 113 via the motor controller 108. The control unit 801 moves the magnetic head 112 to a desired track position on the medium 114 via the head arm 111. The motor controller 108 controls the voice coil motor 110 to control the position of the magnetic head 112. The motor controller 108 controls the spindle motor 113 to rotate the medium 114 at the rated speed. The magnetic head 112 reads out data from the medium 114, and the data is supplied to the read channel 107 through the head IC 109. The read channel 107 decodes the readout data to generate read data. The read channel 107 supplies the read data to the hard disk controller 802 through the AD-DA converter 106. The hard disk controller 802 supplies the read data to the host system 115 through the interface part 103.

[2.2. Control Unit 801]

The control unit 801 includes the hard disk controller 802, the interface part 103, the CPU 104, a memory/ROM 105, the AD-DA converter 106, the read channel 107, and the motor controller 108. The host system 115 is connected to the hard disk controller 802 in the control unit 801 via the interface part 103. The interface part 103 is capable of data communication according to SATA or SAS. The memory/ROM 105 stores programs, etc. necessary to control the operation of the hard disk apparatus 800. The CPU 104 reads out a program, etc. from the memory/ROM 105 to control the operation of the hard disk apparatus 800 via the hard disk controller 802. The memory/ROM 105 has an area into which data can be written and from which part of the data can be deleted. The data to be written on the medium 114, which is received from the host system 115, can be stored in the area.

[2.3. Hard Disk Controller 802]

FIG. 8 is a block diagram showing an example of the configuration of the hard disk apparatus 800, in which the configuration of the hard disk controller 802 in the control unit 801 is illustrated in detail. The hard disk controller 802 according to the second embodiment includes an inversion instruction register 8201, a buffer memory 8202, a syndrome generating circuit 8203, an inverter circuit 8204, a data error detection-correction circuit 8205, an ECC data generating circuit 8206, an inverter circuit 8207, and a DMA controller 8208.

The DMA controller 8208 controls transfer of data in the hard disk controller 802 without depending on the CPU 104. The ECC data generating circuit 8206 generates ECC data to be attached to the data. The syndrome generating circuit 8203 uses the data and the ECC data attached to the data to generate an ECC syndrome (hereinafter simply referred to as a syndrome). The data to which the ECC data is attached is stored in the medium 114 in order to improve the reliability of the hard disk apparatus 800. The hard disk apparatus 800 can perform data correction with the ECC data even if a data error, such as corruption of the data, occurs. The data error detection-correction circuit 8205 refers to the syndrome to detect and correct the data error. The syndrome generating circuit 8203 has a function of an error determination unit.

The hard disk controller 802 according to the second embodiment uses the inversion instruction register 8201, the inverter circuit 8204, and the inverter circuit 8207 to initialize data. The hard disk controller 802 inverts part of the bits of the data to invalidate the data. The hard disk controller 802 initializes the data by invalidating the data. According to the second embodiment, the data has 64 bits and the ECC data attached to 64-bit data has eight bits. The inversion instruction register 8201 stores inversion bit information for identifying two bits among the 64 bits composing the data to be inverted.

When the hard disk controller 802 initializes data and reads out the data from the medium 114, the inverter circuit 8204 reads out the data and specific information in the inversion instruction register 8201 for identifying two bits in the read data to be inverted in the inversion instruction register 8201 from the buffer memory 8202 to invert the specific two bits in the data. The inverter circuit 8204 inverts the specific two bits in the data to generate inverted data. The syndrome generating circuit 8203 uses the inverted data and the corresponding ECC data to generate a syndrome. The data error detection-correction circuit 8205 determines that the data is uncorrectable because of the two-bit error from the syndrome and, thus, determines that the data is invalid. Consequently, the hard disk controller 802 performs the initialization.

When the hard disk controller 802 initializes data and writes the data on the medium 114, the inverter circuit 8207 reads out the data received from the host system 115 (the data stored in the memory/ROM 105 once) and specific information in the inversion instruction register 8201 identifying two bits in the data to be inverted to invert the specific two bits in the data. The inverter circuit 8207 inverts the specific two bits in the data to generate inverted data. The specific two bits in the data inverted by the inverter circuit 8207, are the same as the specific two bits in data that the inverter circuit 8204 inverts. The inverter circuit 8207 stores the inverted data in the buffer memory 8202. ECC data corresponding to the data before the inversion is also stored in the buffer memory 8202. The ECC data generating circuit 8206 reads out the data from the memory/ROM 105 to generate the ECC data and supplies the generated ECC data to the buffer memory 8202. The magnetic head 112 writes the inverted data and the ECC data corresponding to the data before the inversion on the medium 114. When data is read out from the medium 114, the inverter circuit 8204 generates the inverted data. Accordingly, after initialization had been performed in the reading of the data, the data that is written on the medium 114 by inverting specific two bits in the data can be successfully read out from the medium 114.

Although the inverter circuits 8204 and 8207 invert two bits in data to invalidate the data in the second embodiment, the inversion method is not limited to the above one. Multiple bits in the data may be inverted so that the data error detection-correction circuit 8205 cannot perform the data error correction. In other words, the number of bits to be inverted in the data is required to be more than a number of bits the ECC can correct the error, and may be three or more.

The number of patterns of inversion that make the data error uncorrectable in the error correction is equal to the number of combinations that are different from each other in the bits to be inverted, in which the number of bits overlapping between any two of the combinations is not two or more, and corresponds to the number of times when the data initialization process according to the second embodiment can be performed.

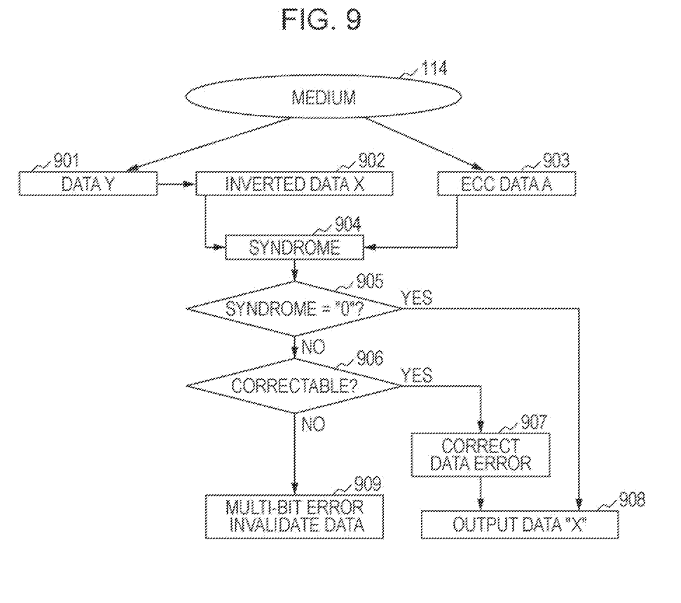

FIG. 9 schematically illustrates an example of an operation of data initialization and read out of data from the medium 114 according to the second embodiment. Readout of data according to the second embodiment will now be described with reference to FIG. 9.

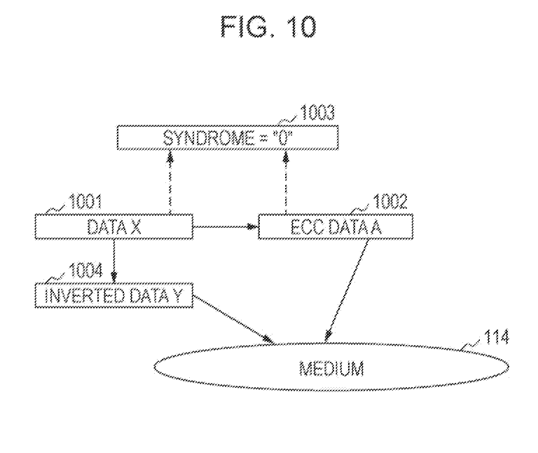

Referring to FIG. 9, in Step 901, the magnetic head 112 reads out data Y from the medium. In Step 903, the magnetic head 112 reads out ECC data A corresponding to the data Y from the medium. In Step 902, the inverter circuit 8204 inverts specific two bits in the data Y to generate inverted data X. The data Y passed through the inverter circuit 8207 (Step 1004 in FIG. 10) in the previous writing of data. In Step 904, the syndrome generating circuit 8203 uses the inverted data X and the ECC data A to generate a syndrome, in which all the bits are set to zero when it is normal. In Step 905, the data error detection-correction circuit 8205 determines whether all the bits in the syndrome are zero. If the data error detection-correction circuit 8205 determines that all the bits in the syndrome are zero (YES in Step 905), in Step 908, the CPU 104 supplies the data X to the host system 115 through the interface part 103. If the data error detection-correction circuit 8205 determines that at least one of all the bits in the syndrome are not zero (NO in Step 905), in Step 906, the data error detection-correction circuit 8205 detects that an error occurs in the data, and determines whether the data error is correctable. If the data error detected by the data error detection-correction circuit 8205 is correctable (YES in Step 906), in Step 907, the data error detection-correction circuit 8205 corrects the data error. In Step 908, the CPU 104 supplies the data X in which the error is corrected in Step 907 to the host system 115 through the interface part 103. If the data error detected by the data error detection-correction circuit 8205 is not correctable (NO in Step 906), in Step 909, the CPU 104 determines that the data error is a multi-bit error and that the data is invalid.

FIG. 10 schematically illustrates an example of an operation of the data initialization and writing of write data on the medium 114 according to the second embodiment. Writing of data according to the second embodiment will now be described with reference to FIG. 10.

In the writing of data on the medium 114, in Steps 1001 and 1002, the ECC data generating circuit 8206 generates ECC data A from data X to be written to the medium. In Step 1003, the syndrome generating circuit 8203 receives the generated ECC data A and the written data X to generate a syndrome which is normal when all the bits are set to zero. In Step 1004, the inverter circuit 8207 generates inverted data Y from the data X. Then, the magnetic head 112 writes the inverted data Y and the ECC data A on the medium 114.

[2.4. Process of Inverting Bits in Data]

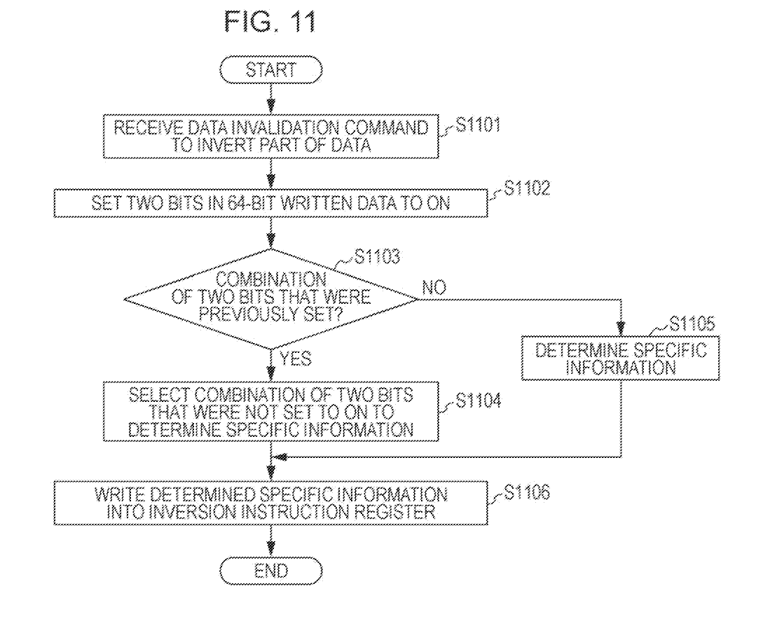

FIG. 11 is a flowchart showing an example of a process of inverting bits in data according to the second embodiment. Referring to FIG. 11, in Step S1101, the control unit 801 receives a data invalidation command to invalidate data by inverting part of the data from the host system 115. In Step S1102, the hard disk controller 802 sets two bits in the data to ON. According to the second embodiment, the length of data is 64 bits and the length of ECC data corresponding to the data is eight bits. The hard disk controller 802 sets two bits in the 64-bit data to ON. Setting the bits to ON means a selection of candidates for bits in the data to be inverted. In Step S1103, the CPU 104 determines whether the combination of two bits that are set to ON coincides with a combination of two bits that were set to ON for the past data initialization. If the combination of two bits that are set to ON by the CPU 104 does not coincide with the combination of two bits that were set to ON in the past (NO in Step S1103), in Step S1105, the CPU 104 selects the two bits set to ON in Step S1102 and thereby determines specific information used for generating inverted data. In Step S1106, the CPU 104 writes the determined specific information into the inversion instruction register 8201 and updates the inversion bit information in the inversion instruction register 8201. If the combination of two bits that are set to ON by the CPU 104 coincides with the combination of two bits that were set to ON in the past (YES in Step S1103), in Step S1104, the CPU 104 selects a combination of two bits in the data, which were not previously set to ON, to determine specific information. In Step S1106, the CPU 104 writes the determined specific information into the inversion instruction register 8201. CPU 104 has a function of an inversion bit control unit.

The specific information identifies the two bits in the data to be inverted in the data and is composed of 64 bits. Bits in the specific information which identify two bits in the data to be inverted are set to “one.” Writing the specific information into the inversion instruction register 8201 means writing the data in which at least one of all the bits are not set to zero and the two bits in the 64 bits are set to “one” into the inversion instruction register 8201.

The inversion instruction register 8201 also stores the specific information that was written to initialize data in the past and that was used in the past data initialization as a history. The inversion instruction register 8201 also has a flag to identify the current specific information used for the current data initialization. Accordingly, in Step S1103, the CPU 104 refers to the history of the specific information that was used for the past data initialization to determine whether the combination of the two bits set to ON coincides with the combination of the two bits that were set to ON in the past. After the CPU 104 writes the specific information into the inversion instruction register 8201 in Step S1106, the flag corresponding to the written specific information is set to ON. If a flag that is set to ON exists, the flag is set to OFF.

[2.5. Data Readout Process]

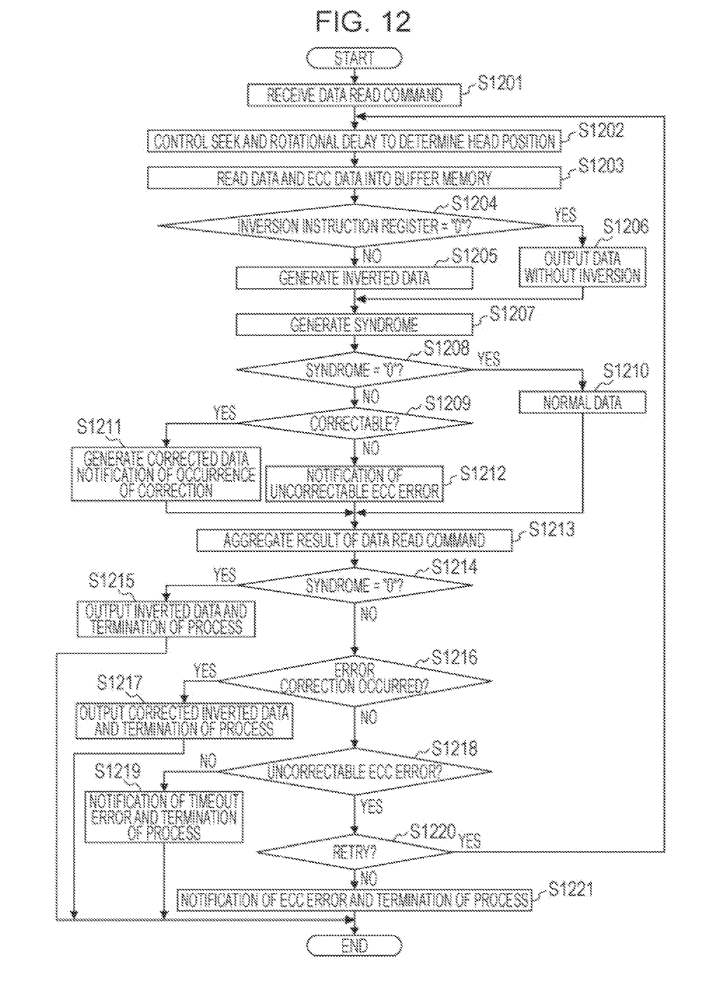

FIG. 12 is a flowchart showing an example of a data readout process according to the second embodiment.

Referring to FIG. 12, in Step S1201, the control unit 801, more specifically, the CPU 104 in the control unit 801 receives a data read command from the host system 115 through the interface part 103. The data read command indicates that data at the W-th address is to be read out and instructs the control unit 801 to access the data at the W-th address in the LBA mode.

In Step S1202, the CPU 104 controls seek and rotational delay in order to determine the position of the magnetic head 112. After the CPU 104 controls the seek and the rotational delay of the magnetic head 112 so that the data at the W-th address can be read out, in Step S1203, the magnetic head 112 reads out data and ECC data corresponding to the data from the medium into the buffer memory 8202 on the basis of the control of the operation by the CPU 104. The buffer memory 8202 has a function of a data receiving unit.

In Step S1204, the CPU 104 determines whether specific information for generating inverted data is written into the inversion instruction register 8201. If the specific information is not written into the inversion instruction register 8201, all the bits in the inversion instruction register are set to zero as an initial value. The fact that all the bits in the inversion instruction register 8201 are set to zero is indicated by “inversion instruction register=“0”” in the flowchart indicating the data readout process in FIG. 12.

If the CPU 104 determines that no specific information is written into the inversion instruction register 8201 (YES in Step S1204), in Step S1206, the inverter circuit 8204 supplies the data read out from the buffer to the syndrome generating circuit 8203 without inverting any bit in the read data. Specifically, the inverter circuit 8204 reads out the data from the buffer memory 8202 and also reads out the data in which all the bits are set to zero when no specific information is written from the inversion instruction register 8201. The inverter circuit 8204 supplies the data to the syndrome generating circuit 8203 without inverting any bit in the data.

If the CPU 104 determines that the specific information is set in the inversion instruction register 8201 (NO in Step S1204), in Step S1205, the inverter circuit 8204 inverts specific two bits in the data to generate inverted data. Specifically, the inverter circuit 8204 reads out the data from the buffer memory 8202 and reads out the specific information written in the inversion instruction register 8201. The inverter circuit 8204 inverts two bits in the data which the specific information indicates to generate inverted data and supplies the generated inverted data to the syndrome generating circuit 8203.

The syndrome generating circuit 8203 receives the ECC data read out from the buffer memory 8202. The data outputted in Step S1206 or the inverted data generated in Step S1205 is supplied from the inverter circuit 8204 to the syndrome generating circuit 8203. In Step S1207, the syndrome generating circuit 8203 generates a syndrome from the data (or the inverted data) and the ECC data corresponding to the data.

In Step S1208, the data error detection-correction circuit 8205 determines whether all the bits in the syndrome are set to zero. If the data error detection-correction circuit 8205 determines that all the bits in the syndrome are set to zero (YES in Step S1208), in Step S1210, the data error detection-correction circuit 8205 determines that the data is normal. If the data error detection-correction circuit 8205 determines that at least one of all the bits in the syndrome are not set to zero (NO in Step S1208), in Step S1209, the data error detection-correction circuit 8205 detects that an error occurs in the data and determines whether the data error is correctable.

If the data error detection-correction circuit 8205 determines that the data error is correctable (YES in Step S1209), in Step S1211, the data error detection-correction circuit 8205 corrects the data error to generate corrected data and notifies the CPU 104 of the occurrence of the correction. If the data error detection-correction circuit 8205 determines that the data error is not correctable (NO in Step S1209), in Step S1212, the data error detection-correction circuit 8205 notifies the CPU 104 of the uncorrectable ECC error.

In Step S1213, the CPU 104 aggregates the result of the readout of the data for the data read command received from the host system 115. The control unit 801 performs the following analysis on the basis of the result of the readout of the data aggregated by the CPU 104. Then, the data readout process is terminated.

In Step S1214, the control unit 801 determines whether all the bits in the syndrome generated by the syndrome generating circuit 8203 are set to zero. If the control unit 801 determines that all the bits in the syndrome generated by the syndrome generating circuit 8203 are set to zero (YES in Step S1214), in Step S1215, the control unit 801 supplies the inverted data to the host system 115 through the interface part 103. Then, the data readout process is terminated. If the control unit 801 determines that at least one of all the bits in the syndrome generated by the syndrome generating circuit 8203 are not set to zero (NO in Step S1214), in Step S1216, the CPU 104 determines whether a notification that the correction of the data error occurred is received from the data error detection-correction circuit 8205. If the CPU 104 determines that a notification that the correction of the data error occurred is received from the data error detection-correction circuit 8205 (YES in Step S1216), in Step S1217, the control unit 801 supplies the corrected inverted data to the host system 115 through the interface part 103. Then, the data readout process is terminated. If the CPU 104 determines that a notification that the correction of the data error occurred is not received from the data error detection-correction circuit 8205 (NO in Step S1216), in Step S1218, the CPU 104 determines whether a notification that the uncorrectable ECC error occurred is received from the data error detection-correction circuit 8205. If the CPU 104 determines that a notification that the uncorrectable ECC error occurred is not received from the data error detection-correction circuit 8205 (NO in Step S1218), in Step S1219, the control unit 801 does not supply the data to the host system 115 and notifies the host system 115 of a timeout error. Then, the data readout process is terminated. If the CPU 104 determines that a notification that the uncorrectable ECC error occurred is received from the data error detection-correction circuit 8205 (YES in Step S1218), in Step S1220, the CPU 104 determines whether to retry the readout of data. If the CPU 104 determines to retry the readout of data (YES in Step S1220), the process goes back to Step S1202 and the CPU 104 controls the seek and the rotational delay again in order to determine the position of the magnetic head 112. If the CPU 104 determines not to retry the readout of data (NO in Step S1220), in Step S1221, the CPU 104 notifies the host system 115 that the ECC error occurred in the read data through the interface part 103. Then, the data readout process is terminated.

[2.6. Data Writing Process]

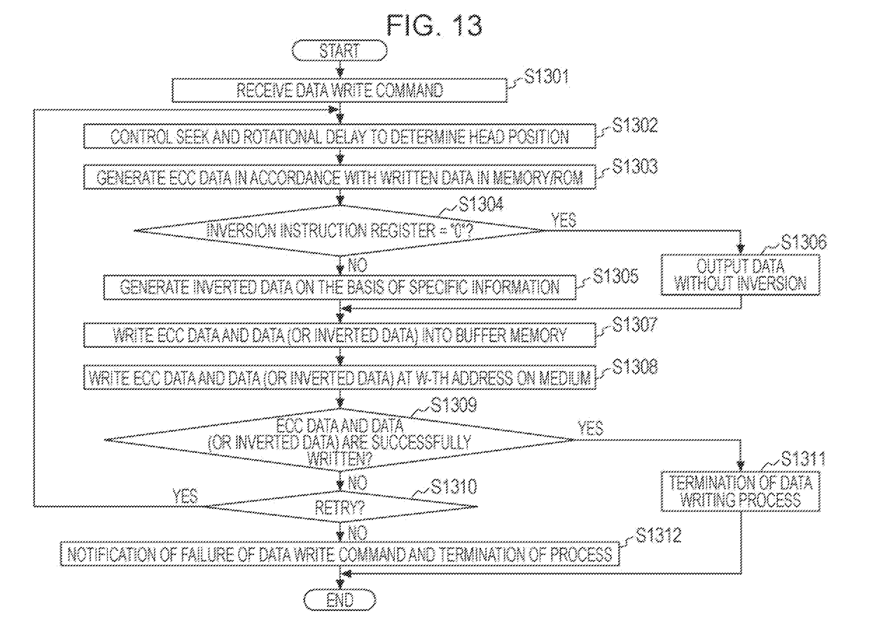

FIG. 13 is a flowchart showing an example of a data writing process according to the second embodiment.

Referring to FIG. 13, in Step S1301, the control unit 801, more specifically, the CPU 104 in the control unit 801 receives a data write command from the host system 115 through the interface part 103. The data write command indicates that data is to be written at the W-th address and instructs the control unit 801 to access the data at the W-th address in the LBA mode. The control unit 801 receives write to be written into the medium data through the interface part 103 and stores the write data in the memory/ROM 105.

In Step S1302, the CPU 104 controls the seek and the rotational delay in order to determine the position of the magnetic head 112. In Step S1303, the ECC data generating circuit 8206 reads out the write data stored in the memory/ROM 105 to generate ECC data corresponding to the write data.

In Step S1304, the CPU 104 determines whether specific information for generating inverted data is written into the inversion instruction register 8201. If the CPU 104 determines that no specific information is written into the inversion instruction register 8201 (YES in Step S1304), in Step S1306, the inverter circuit 8207 supplies the data to the buffer memory 8202 without inverting the data. Specifically, the data is supplied from the memory/ROM 105 to the inverter circuit 8207 under the control of the CPU 104. The inverter circuit 8207 reads out the data in which all the bits are set to zero in a case when no specific information is written, from the inversion instruction register 8201. The inverter circuit 8207 supplies the data to the buffer memory 8202 without inverting any bit in the data.

If the CPU 104 determines that the specific information is set in the inversion instruction register 8201 (NO in Step S1304), in Step S1305, the inverter circuit 8207 inverts specific two bits in the data to generate inverted data. Specifically, the data is supplied from the memory/ROM 105 to the inverter circuit 8207 under the control of the CPU 104. The inverter circuit 8207 reads out the specific information written in the inversion instruction register 8201. The inverter circuit 8207 inverts two bits in the data indicated by the specific information to generate inverted data.

In Step S1307, the ECC data generating circuit 8206 writes the generated ECC data into the buffer memory 8202 and the inverter circuit 8207 writes the data outputted in Step S1306 or the inverted data generated in Step S1305 into the buffer memory 8202. In Step S1308, the CPU 104 writes the data (or the inverted data) and the ECC data stored in the buffer memory 8202 at the W-th address of the medium 114. Specifically, the CPU 104 accesses the W-th address of the medium 114 in the LBA mode to write the data (or the inverted data) and the ECC data at the W-th address of the medium 114 through the AD-DA converter 106 and the read channel 107.

In Step S1309, the CPU 104 determines whether the data (or the inverted data) and the ECC data are successfully written at the W-th address of the medium 114. If the CPU 104 determines that the data (or the inverted data) and the ECC data are successfully written at the W-th address of the medium 114 (YES in Step S1309), in Step S1311, the control unit 801 notifies the host system 115 that the data writing process is successfully performed through the interface part 103. Then, the data writing process is terminated. If the CPU 104 determines that the data (or the inverted data) and the ECC data are not successfully written at the W-th address of the medium 114 (NO in Step S1309), in Step S1310, the CPU 104 determines whether to retry the writing of data. If the CPU 104 determines that the writing of data is retried (YES in Step S1310), the process goes back to Step S1302 and the CPU 104 controls the seek and the rotational delay again in order to determine the position of the magnetic head 112. If the CPU 104 determines not for retry the writing of data (NO in Step S1310), in Step S1312, the control unit 801 notifies the host system 115 that the data writing process is failed through the interface part 103. Then, the data writing process is terminated.

### Third Embodiment

A case in which part of the bits in data is inverted and ECC data is generated from the inverted data to invalidate (initialize) the data will now be described as a third embodiment of the present invention.

[3.1. Hard Disk Apparatus 1400]

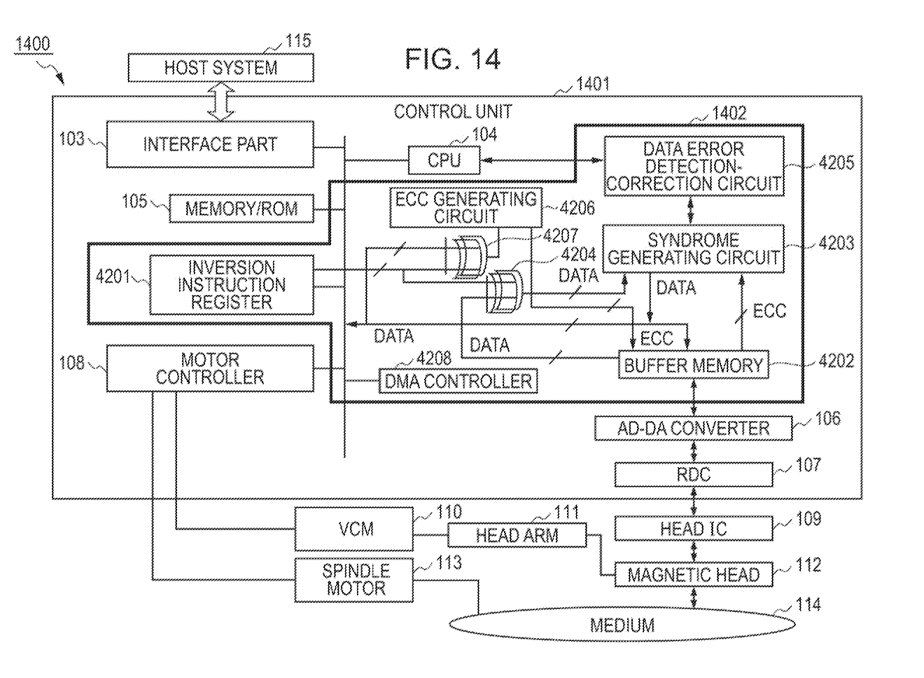

FIG. 14 is a block diagram showing an example of the configuration of a hard disk apparatus 1400 according to the third embodiment. Referring to FIG. 14, the hard disk apparatus 1400 is connected to a host system 115 and is a storage medium capable of writing and reading out data. The host system 115 is connected to an input apparatus, a display apparatus, and so on including the hard disk apparatus 1400 and controls the entire system. According to the third embodiment, the host system 115 is, for example, a RAID apparatus. When the host system 115 is a RAID apparatus, the host system 115 manages the hard disk apparatus 1400 on the basis of, for example, whether the hard disk apparatus 1400 is a master disk or a slave disk by using a system area provided in the storage region in the hard disk apparatus 1400. Accordingly, it is necessary to set the hard disk apparatus 1400 to an initialization state to connect the hard disk apparatus 1400 to the host system 115. In other words, when data is written into the hard disk apparatus 1400 before the hard disk apparatus 1400 is connected to a RAID apparatus, it is necessary to connect the hard disk apparatus 1400 that has been initialized to the RAID apparatus. This is because the entire system can possibly malfunction if the hard disk apparatus 1400 is connected to, for example, a RAID apparatus in a state in which data is written into the system area in the hard disk apparatus 1400. The hard disk apparatus 1400 according to the third embodiment is capable of performing a high-speed data initialization process, and it is possible to prevent malfunction of the system in reuse of the hard disk apparatus 1400. The configuration of the hard disk apparatus 1400 and the data initialization process in the hard disk apparatus 1400 will now be described.

The hard disk apparatus 1400 includes a control unit 1401, a head IC 109, a voice coil motor (VCM) 110, a head arm 111, a magnetic head 112, a spindle motor 113, and a medium 114. The control unit 1401 is a example of a control apparatus The hard disk apparatus 1400 controls writing and readout of data on the basis of an instruction from the host system 115.

In writing data into the hard disk apparatus 1400, the host system 115 supplies a write command and write data to he written into the medium to the control unit 1401 through an interface part 103. A central processing unit (CPU) 104 controls the voice coil motor 110 and the spindle motor 113 via a motor controller 108. The motor controller 108 controls the voice coil motor 110 to control the position of the magnetic head 112. The control unit 1401 moves the magnetic head 112 to a desired track position on the medium 114 via the head arm 111. The motor controller 108 controls the spindle motor 113 to rotate the medium 114 at a rated speed. A hard disk controller 1402 supplies the write data to a read channel (RDC) 107 through an analog to digital-digital to analog (AD-DA) converter 106. The read channel 107 encodes the write data to supply the encoded write data to the head IC 109. The head IC 109 supplies the encoded write data to the magnetic head 112 that writes the write data on the medium 114. The rated speed means a speed of rotation of the medium 114, at which the hard disk apparatus 1400 can offer the proper performance under predetermined normal working conditions, for example, at about one atmosphere and at room temperature.

In reading data from the hard disk apparatus 1400, the host system 115 supplies a read command (a read instruction) to the control unit 1401 through the interface part 103. The hard disk controller 1402 supplies the read command to the CPU 104. The CPU 104 analyzes the received read command and notifies the hard disk controller 1402 of information about the position of the medium from which the data is read out to control the voice coil motor 110 and the spindle motor 113 via the motor controller 108. The control unit 1401 moves the magnetic head 112 to a desired track position on the medium 114 via the head arm 111. The motor controller 108 controls the voice coil motor 110 to control the position of the magnetic head 112. The motor controller 108 controls the spindle motor 113 to rotate the medium 114 at the rated speed. The magnetic head 112 reads out data from the medium 114, and the data is supplied to the read channel 107 through the head IC 109. The read channel 107 decodes the readout data to generate read data. The read channel 107 supplies the read data to the hard disk controller 1402 through the AD-DA converter 106. The hard disk controller 1402 supplies the read data to the host system 115 through the interface part 103.

[3.2. Control Unit 1401]

The control unit 1401 includes the hard disk controller 1402, the interface part 103, the CPU 104, a memory/ROM 105, the AD-DA converter 106, the read channel 107, and the motor controller 108. The host system 115 is connected to the hard disk controller 1402 in the control unit 1401 via the interface part 103. The interface part 103 is capable of data communication according to SATA or SAS. The memory/ROM 105 stores programs, etc. necessary to control the operation of the hard disk apparatus 1400. The CPU 104 reads out a program, etc. from the memory/ROM 105 to control the operation of the hard disk apparatus 1400 via the hard disk controller 1402. The memory/ROM 105 has an area into which data can be written and from which part of the data can be deleted. The data to be written on the medium 114, which is received from the host system 115, can be stored in the area.

[3.3. Hard Disk Controller 1402]

FIG. 14 is a block diagram showing an example of the configuration of the hard disk apparatus 1400, in which the configuration of the hard disk controller 1402 in the control unit 1401 is illustrated in detail. The hard disk controller 1402 according to the third embodiment includes an inversion instruction register 4201, a buffer memory 4202, a syndrome generating circuit 4203, an inverter circuit 4204, a data error detection-correction circuit 4205, an ECC data generating circuit 4206, an inverter circuit 4207, and a DMA controller 4208.

The DMA controller 4208 controls transfer of data in the hard disk controller 1402 without depending on the CPU 104. The ECC data generating circuit 4206 generates ECC data to be attached to the data. The syndrome generating circuit 4203 uses the data and the ECC data attached to the data to generate an ECC syndrome (hereinafter simply referred to as a syndrome). The data to which the ECC data is attached is stored in the medium 114 in order to improve the reliability of the hard disk apparatus 1400. The hard disk apparatus 1400 can perform data correction with the ECC data even if a data error, such as corruption of the data, occurs. The data error detection-correction circuit 4205 refers to the syndrome to detect and correct the data error. The syndrome generating circuit 4203 has a function of an error determination unit.

The hard disk controller 1402 according to the third embodiment uses the inversion instruction register 4201, the inverter circuit 4204, and the inverter circuit 4207 to initialize data. The hard disk controller 1402 inverts part of the bits of the data to invalidate the data. The hard disk controller 1402 initializes the data by invalidating the data. According to the third embodiment, the data has 64 bits and the ECC data attached to 64-bit data has eight bits. The inversion instruction register 4201 stores inversion bit information for identifying two bits among the 64 bits composing the data to be inverted.

When the hard disk controller 1402 initializes data and reads out the data from the medium 114, the inverter circuit 4204 reads out the data and specific information in the inversion instruction register 4201 for identifying two bits in the read data to be inverted from the buffer memory 4202 to invert the specific two bits in the data. The inverter circuit 4204 inverts the specific two bits in the data to generate inverted data. The syndrome generating circuit 4203 uses the inverted data and the corresponding ECC data to generate a syndrome. The data error detection-correction circuit 4205 determines that the data is uncorrectable because of the two-bit error from the syndrome and, thus, determines that the data is invalid. Consequently, the hard disk controller 1402 performs the initialization.

When the hard disk controller 1402 initializes data and writes the data on the medium 114, the inverter circuit 4207 reads out the data received from the host system 115 (the data stored in the memory/ROM 105 once) and specific information in the inversion instruction register 4201 identifying two bits in the data to be inverted to invert the specific two bits in the data. The inverter circuit 4207 inverts the specific two bits in the data to generate inverted data. The specific two bits in the data inverted by the inverter circuit 4207 are the same as the specific two bits in data that the inverter circuit 4204 inverts. The inverter circuit 4207 supplies the inverted data to the ECC data generating circuit 4206. The ECC data generating circuit 4206 generates ECC data (hereinafter referred to as post-inversion ECC data) corresponding to the inverted data and supplies the generated inverted ECC data to the buffer memory 4202. The data stored in the memory/ROM 105 is supplied to the buffer memory 4202 under the control of the CPU 104. The magnetic head 112 writes the data and the inverted ECC data on the medium 114. When data is read out from the medium 114, the inverter circuit 4204 generates the inverted data. Accordingly, after initialization has been performed in the reading of the data, the data that is written on the medium 114 by inverting specific two bits in the data are inverted again can be successfully read out from the medium 114.

Although the inverter circuits 4204 and 4207 invert two bits in data to invalidate the data in the third embodiment, the inversion method is not limited to the above one. Multiple bits in the data may be inverted so that the data error detection-correction circuit 4205 cannot perform the data error correction. In other words, the number of bits to be inverted in the data is required to be more than a number of bits of which the ECC can correct the error, and may be three or more.

The number of patterns of inversion that make the data error uncorrectable in the error correction is equal to the number of combinations that are different from each other in the bits to be inverted, in which the number of bits overlapping between any two of the combinations is not two or more, and corresponds to the number of times the data initialization process according to the third embodiment can be performed.

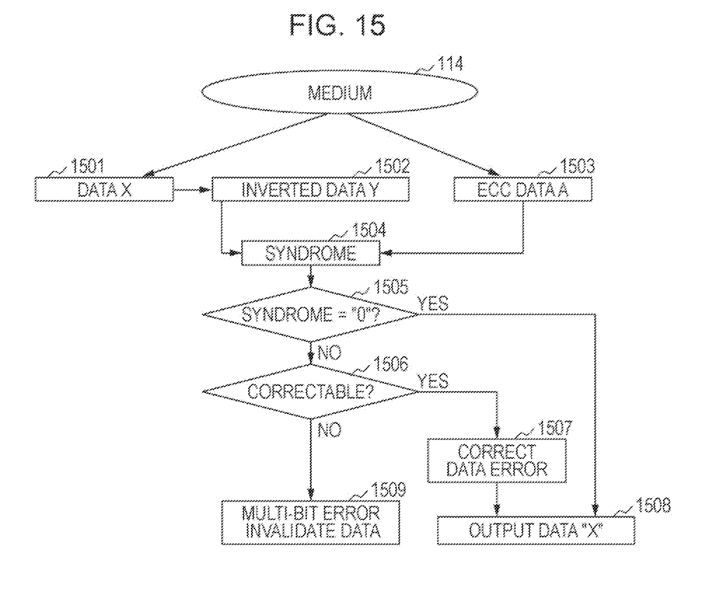

FIG. 15 schematically illustrates an example of an operation of data initialization and read out of data from the medium 114 according to the third embodiment. Readout of data according to the third embodiment will now be described with reference to FIG. 15.

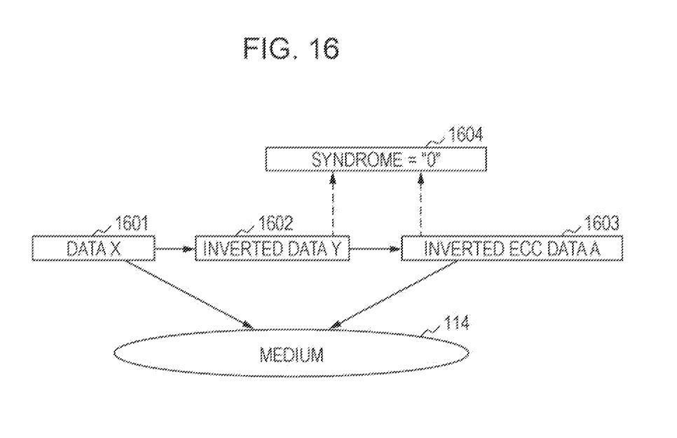

Referring to FIG. 15, in Step 1501, the magnetic head 112 reads out data X from the medium. In Step 1503, the magnetic head 112 reads out ECC data A corresponding to the data X from the medium. In Step 1502, the inverter circuit 4204 inverts specific two bits in the data X to generate inverted data Y. The ECC data A is generated from the data which passed through the inverter circuit 4207 (Step 1602 in FIG. 16) in the previous writing of data. In Step 1504, the syndrome generating circuit 4203 uses the inverted data Y and the ECC data A to generate a syndrome, in which all the bits are set to zero when it is normal. In Step 1505, the data error detection-correction circuit 4205 determines whether all the bits in the syndrome are zero. If the data error detection-correction circuit 4205 determines that all the bits in the syndrome are zero (YES in Step 1505), in Step 1508, the CPU 104 supplies the data X to the host system 115 through the interface part 103. If the data error detection-correction circuit 4205 determines that at least one of all the bits in the syndrome are not zero (NO in Step 1505), in Step 1506, the data error detection-correction circuit 4205 detects that an error occurs in the data, and determines whether the syndrome indicates a correctable data error, such as a single-bit error. If the data error detected by the data error detection-correction circuit 4205 is correctable (YES in Step 1506), in Step 1507, the data error detection-correction circuit 4205 corrects the data error. In Step 1508, the CPU 104 supplies the data X in which the error is corrected in Step 1507 to the host system 115 through the interface part 103. If the data error detected by the data error detection-correction circuit 4205 is not correctable (NO in Step 1506), in Step 1509, the CPU 104 determines that the data error is a multi-bit error and that the data is invalid.

FIG. 16 schematically illustrates an example of an operation of the data initialization and writing of data on the medium 114 according to the third embodiment. Writing of data according to the third embodiment will now be described with reference to FIG. 16.

In the writing of data on the medium 114, in Steps 1601 and 1602, the inverter circuit 4207 generates inverted data Y from data X to be written to the medium. In Step 1603, the ECC data generating circuit 4206 generates inverted ECC data A from the inverted data Y. In Step 1604, the syndrome generating circuit 4203 generates a syndrome, which is normal when all the bits are set to zero. Then, the magnetic head 112 writes the data X and the inverted ECC data A on the medium 114.

[3.4. Process of Inverting Bits in Data]

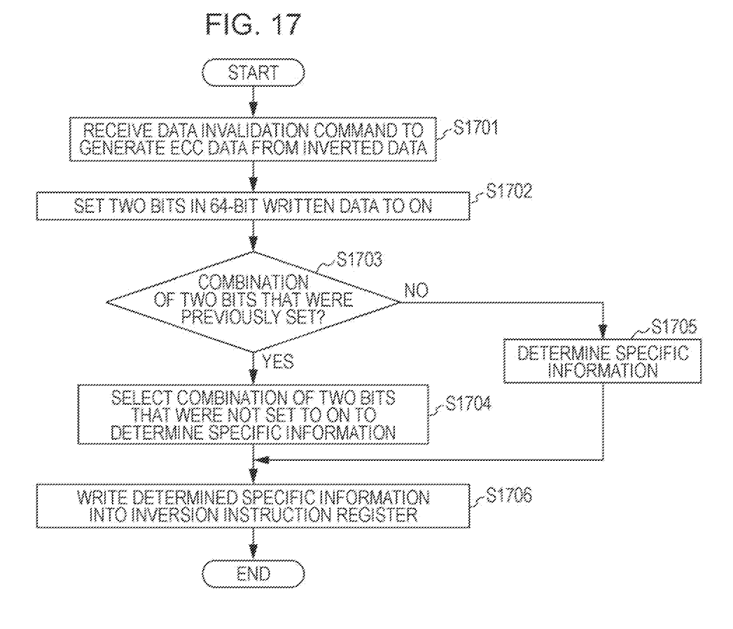

FIG. 17 is a flowchart showing an example of a process of inverting bits in data according to the third embodiment. Referring to FIG. 17, in Step S1701, the control unit 1401 receives a data invalidation command to invalidate data by inverting part of the data from the host system 115. In Step S1702, the hard disk controller 1402 sets two bits in the data to ON. According to the third embodiment, the length of data is 64 bits and the length of ECC data corresponding to the data is eight bits. The hard disk controller 1402 sets two bits in the 64-bit data to ON. Setting the bits to ON means a selection of candidates for bits in the data to be inverted. In Step S1703, the CPU 104 determines whether the combination of two bits that are set to ON coincides with a combination of two bits that were set to ON for the past data initialization. If the combination of two bits that are set to ON by the CPU 104 does not coincide with the combination of two bits that were set to ON in the past (NO in Step S1703), in Step S1705, the CPU 104 selects the two bits set to ON in Step S1702 and thereby determines specific information used for generating inverted data. In Step S1706, the CPU 104 writes the determined specific information into the inversion instruction register 4201. If the combination of two bits that are set to ON by the CPU 104 coincides with the combination of two bits that were set to ON in the past (YES in Step S1703), in Step S1704, the CPU 104 selects a combination of two bits in the data, which were not previously set to ON, to determine specific information. In Step S1706, the CPU 104 writes the determined specific information into the inversion instruction register 4201. CPU 104 has a function of an inversion bit control unit.

The specific information identifies the two bits in the data to be inverted and is composed of 64 bits. Bits in the specific information which identify two bits in the data to be inverted are set to “one.” Writing the specific information into the inversion instruction register 4201 means writing the data in which at least one of all the bits are not set to zero and the two bits in the 64 bits are set to “one” into the inversion instruction register 4201.

The inversion instruction register 4201 also stores the specific information that was written to initialize data in the past and that was used in the past data initialization as a history. The inversion instruction register 4201 also has a flag to identify the current specific information used for the current data initialization. Accordingly, in Step S1703, the CPU 104 refers to the history of the specific information that was used for the past data initialization to determine whether the combination of the two bits set to ON coincides with the combination of the two bits that were set to ON in the past. After the CPU 104 writes the specific information into the inversion instruction register 4201 in Step S1706, the flag corresponding to the written specific information is set to ON. If a flag that is set to ON exists, the flag is set to OFF.

[3.5. Data Readout Process]

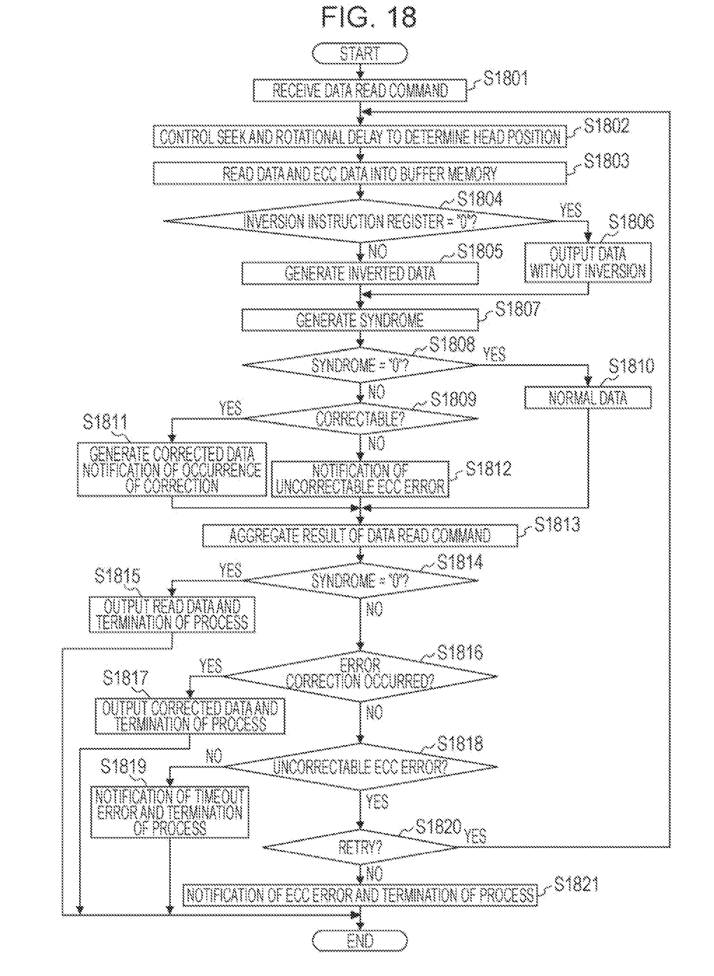

FIG. 18 is a flowchart showing an example of a data readout process according to the third embodiment.

Referring to FIG. 18, in Step S1801, the control unit 1401, more specifically, the CPU 104 in the control unit 1401 receives a data read command from the host system 115 through the interface part 103. The data read command indicates that data at the W-th address is to be read out and instructs the control unit 1401 to access the data at the W-th address in the LBA mode.

In Step S1802, the CPU 104 controls seek and rotational delay in order to determine the position of the magnetic head 112. After the CPU 104 controls the seek and the rotational delay of the magnetic head 112 so that the data at the W-th address can be read out, in Step S1803, the magnetic head 112 reads out data and ECC data corresponding to the data from the medium into the buffer memory 4202 on the basis of the control of the operation by the CPU 104. The buffer memory 4202 has a function of as a data receiving unit.

In Step S1804, the CPU 104 determines whether specific information for generating inverted data is written into the inversion instruction register 4201. If the specific information is not written into the inversion instruction register 4201, all the bits in the inversion instruction register are set to zero as an initial value. The fact that all the bits in the inversion instruction register 4201 are set to zero is indicated by “inversion instruction register=“0”” in the flowchart indicating the data readout process in FIG. 18.

If the CPU 104 determines that no specific information is written into the inversion instruction register 4201 (YES in Step S1804), in Step S1806, the inverter circuit 4204 supplies the data read out from the buffer to the syndrome generating circuit 4203 without inverting any bit in the data because all the bits in the inversion instruction register 4201 are set to zero. Specifically, the inverter circuit 4204 reads out the data from the buffer memory 4202 and also reads out the data in which all the bits are set to zero when no specific information is written from the inversion instruction register 4201. The inverter circuit 4204 supplies the data to the syndrome generating circuit 4203 without inverting any bit in the data.

If the CPU 104 determines that the specific information is set in the inversion instruction register 4201 (NO in Step S1804), in Step S1805, the inverter circuit 4204 inverts specific two bits in the data to generate inverted data. Specifically, the inverter circuit 4204 reads out the data from the buffer memory 4202 and reads out the specific information written in the inversion instruction register 4201. The inverter circuit 4204 inverts two bits in the data that the specific information indicates to generate inverted data and supplies the generated inverted data to the syndrome generating circuit 4203.

The syndrome generating circuit 4203 receives the ECC data read out from the buffer memory 4202. The data outputted in Step S1806 or the inverted data generated in Step S1805 is supplied from the inverter circuit 4204 to the syndrome generating circuit 4203. In Step S1807, the syndrome generating circuit 4203 generates a syndrome from the data (or the inverted data) and the ECC data corresponding to the data (or the inverted data).

In Step S1808, the data error detection-correction circuit 4205 determines whether all the bits in the syndrome are set to zero. If the data error detection-correction circuit 4205 determines that all the bits in the syndrome are set to zero (YES in Step S1808), in Step S1810, the data error detection-correction circuit 4205 determines that the data is normal. If the data error detection-correction circuit 4205 determines that at least one of all the bits in the syndrome are not set to zero (NO in Step S1808), in Step S1809, the data error detection-correction circuit 4205 detects that an error occurs in the data and determines whether the data error is correctable.

If the data error detection-correction circuit 4205 determines that the data error is correctable (YES in Step S1809), in Step S1811, the data error detection-correction circuit 4205 corrects the data error to generate corrected data and notifies the CPU 104 of the occurrence of the correction. If the data error detection-correction circuit 4205 determines that the data error is not correctable (NO in Step S1809), in Step S1812, the data error detection-correction circuit 4205 notifies the CPU 104 of the uncorrectable ECC error.

In Step S1813, the CPU 104 aggregates the result of the readout of the data for the data read command received from the host system 115. The control unit 1401 performs the following analysis on the basis of the result of the readout of the data aggregated by the CPU 104. Then, the data readout process is terminated.

In Step S1814, the control unit 1401 determines whether all the bits in the syndrome generated by the syndrome generating circuit 4203 are set to zero. If the control unit 1401 determines that all the bits in the syndrome generated by the syndrome generating circuit 4203 are set to zero (YES in Step S1814), in Step S1815, the control unit 1401 supplies the data to the host system 115 through the interface part 103. Then, the data readout process is terminated. If the control unit 1401 determines that at least one of all the bits in the syndrome generated by the syndrome generating circuit 4203 are not set to zero (NO in Step S1814), in Step S1816, the CPU 104 determines whether a notification that the correction of the data error occurred is received from the data error detection-correction circuit 4205. If the CPU 104 determines that a notification that the correction of the data error occurred is received from the data error detection-correction circuit 4205 (YES in Step S1816), in Step S1817, the control unit 1401 supplies the corrected data to the host system 115 through the interface part 103. Then, the data readout process is terminated. If the CPU 104 determines that a notification that the correction of the data error occurred is not received from the data error detection-correction circuit 4205 (NO in Step S1816), in Step S1818, the CPU 104 determines whether a notification that the uncorrectable ECC error occurred is received from the data error detection-correction circuit 4205. If the CPU 104 determines that a notification that the uncorrectable ECC error occurred is not received from the data error detection-correction circuit 4205 (NO in Step S1818), in Step S1819, the control unit 1401 does not supply the data to the host system 115 and notifies the host system 115 of a timeout error. Then, the data readout process is terminated. If the CPU 104 determines that a notification that the uncorrectable ECC error occurred is received from the data error detection-correction circuit 4205 (YES in Step S1818), in Step S1820, the CPU 104 determines whether to retry the readout of data. If the CPU 104 determines to retry the readout of data (YES in Step S1820), the process goes back to Step S1802 and the CPU 104 controls the seek and the rotational delay again in order to determine the position of the magnetic head 112. If the CPU 104 determines not to retry the readout of data is not retried (NO in Step S1820), in Step S1821, the CPU 104 notifies the host system 115 that the ECC error occurred in the read data through the interface part 103. Then, the data readout process is terminated.

[3.6. Data Writing Process]

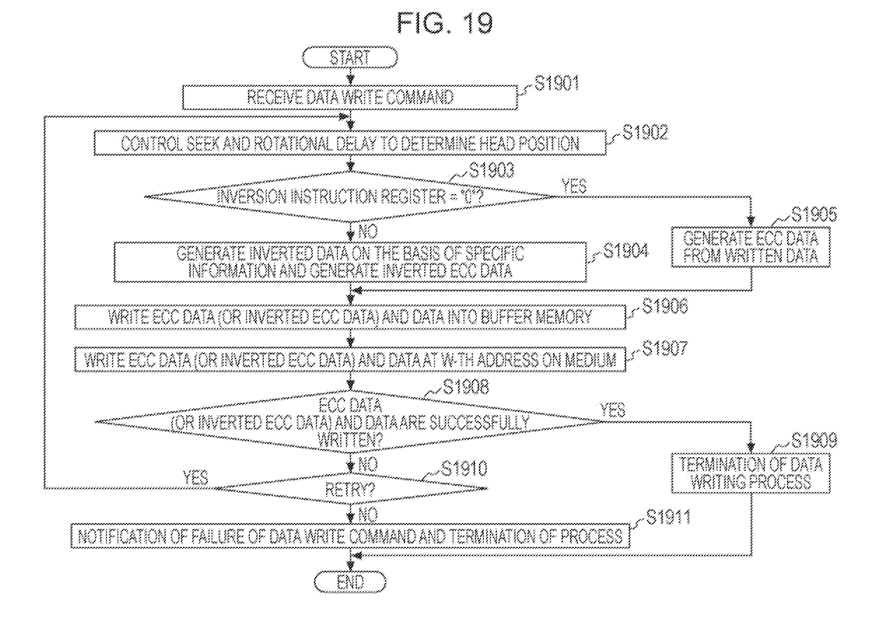

FIG. 19 is a flowchart showing an example of a data writing process according to the third embodiment.

Referring to FIG. 19, in Step S1901, the control unit 1401, more specifically, the CPU 104 in the control unit 1401 receives a data write command from the host system 115 through the interface part 103. The data write command indicates that data is to be written at the W-th address and instructs the control unit 1401 to access the data at the W-th address in the LBA mode. The control unit 1401 receives write data to be written into the medium through the interface part 103 and stores the write data in the memory/ROM 105.

In Step S1902, the CPU 104 controls the seek and the rotational delay in order to determine the position of the magnetic head 112.

In Step S1903, the CPU 104 determines whether specific information for generating inverted data is written into the inversion instruction register 4201. If the CPU 104 determines that no specific information is written into the inversion instruction register 4201 (YES in Step S1903), in Step S1905, the inverter circuit 4207 supplies the data to the ECC data generating circuit 4206 without inverting the data and the ECC data generating circuit 4206 generates ECC data from the data. Specifically, the data is supplied from the memory/ROM 105 to the inverter circuit 4207 under the control of the CPU 104. The inverter circuit 4207 reads out the data in which all the bits are set to zero in a case when no specific information is written, from the inversion instruction register 4201. The inverter circuit 4207 supplies the data to the ECC data generating circuit 4206 without inverting any bit in the data. The ECC data generating circuit 4206 generates ECC data from the data.

If the CPU 104 determines that the specific information is set in the inversion instruction register 4201 (NO in Step S1903), in Step S1904, the inverter circuit 4207 inverts specific two bits in the data to generate inverted data and the ECC data generating circuit 4206 generates inverted ECC data from the inverted data. Specifically, the data is supplied from the memory/ROM 105 to the inverter circuit 4207 under the control of the CPU 104. The inverter circuit 4207 reads out the specific information written in the inversion instruction register 4201. The inverter circuit 4207 inverts two bits in the data indicated by the specific information to generate inverted data and supplies the inverted data to the ECC data generating circuit 4206. The ECC data generating circuit 4206 generates inverted ECC data from the inverted data.

In Step S1906, the ECC data generating circuit 4206 writes the generated ECC data outputted in Step S1905 or the inverted ECC data generated in Step S1904 into the buffer memory 4202 and the CPU 104 writes the data in the memory/ROM 105 into the buffer memory 4202. In Step S1907, the CPU 104 writes the data and the ECC data (or the inverted ECC data) stored in the buffer memory 4202 at the W-th address of the medium 114. Specifically, the CPU 104 accesses the W-th address of the medium 114 in the LBA mode to write the data and the ECC data (or the inverted ECC data) at the W-th address of the medium 114 through the AD-DA converter 106 and the read channel 107.

In Step S1908, the CPU 104 determines whether the data and the ECC data (or the inverted ECC data) are successfully written at the W-th address of the medium 114. If the CPU 104 determines that the data and the ECC data (or the inverted ECC data) are successfully written at the W-th address of the medium 114 (YES in Step S1908), in Step S1909, the control unit 1401 notifies the host system 115 that the data writing process is successfully performed through the interface part 103. Then, the data writing process is terminated. If the CPU 104 determines that the data and the ECC data (or the inverted ECC data) are not successfully written at the W-th address of the medium 114 (NO in Step S1908), in Step S1910, the CPU 104 determines whether to retry the writing of data. If the CPU 104 determines that the writing of data is retried (YES in Step S1910), the process goes back to Step S1902 and the CPU 104 controls the seek and the rotational delay again in order to determine the position of the magnetic head 112. If the CPU 104 determines not to retry the writing of data (NO in Step S1910), in Step S1911, the control unit 1401 notifies the host system 115 that the data writing process is failed through the interface part 103. Then, the data writing process is terminated.

With a data initialization method according to the above embodiments, it is possible to rapidly initialize a storage medium to reuse the storage medium and prevent malfunction of a system that reuses the storage medium by inverting multiple bits in data written in the storage medium in advance or in an error correcting code attached to the data to invalidate data that is read out.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has(have) been described in detail, it should be understood that the various changes, substitutions, and alterations could be made hereto without departing from the spirit and scope of the invention.

What is claimed is:

1. A control apparatus for controlling initialization of data stored in a storage unit in response to receipt of an initialization instruction from a host system, comprising:
a register unit that stores inversion bit information indicating a plurality of bits to be inverted in data readout process, the plurality of bits to be inverted in data readout process being part of bits of at least one of read data that is read from the storage unit and an error correcting code corresponding to the read data;
a data receiving unit that receives the read data and the error correcting code corresponding to the read data, the read data and the error correcting code corresponding to the read data being read from the storage unit; and
an inversion unit that inverts part of bits of at least one of the read data and the error correcting code corresponding to the read data on the basis of the inversion bit information in the data readout process after the receipt of the initialization instruction.

2. The control apparatus according to claim 1,
wherein the inversion bit information further indicates a plurality of bits to be inverted in data writing process, the plurality of bits to be inverted in data writing process being part of bits of at least one of write data that is to be written to the storage unit and an error correcting code corresponding to the write data, and
the inversion unit inverts part of bits of at least one of the write data and an error correcting code corresponding to the write data on the basis of the inversion bit information in the data writing process after the initialization of data is performed.

3. The control apparatus according to claim 1,
wherein the inversion bit information includes a plurality of inversion bit information pieces and a plurality of flags each corresponding to one of the plurality of inversion bit information pieces, the flag indicating whether the corresponding inversion bit information piece is valid or not, and
the inversion unit inverts the part of bits of the first data or the first error correcting code on the basis of the inversion bit information piece in which the corresponding flag indicates the inversion bit information piece is valid.

4. The control apparatus according to claim 1, further comprising:
an error determination unit that detects whether there is a data error in the read data on the basis of the read data and the inverted error correcting code corresponding to the read data.

5. The control apparatus according to claim 1, further comprising:
an error determination unit that determines whether there is a data error in the inverted read data on the basis of the inverted read data and the error correcting code corresponding to the read data.

6. The control apparatus according to claim 1, further comprising:
an error determination unit that determines whether there is a data error in the read data on the basis of the inverted read data and the error correcting code corresponding to the read data.

7. The control apparatus according to claim 1,
wherein the number of the plurality of bits to be inverted is more than a number of bits correctable by the error correcting code corresponding to the read data.

8. A nonvolatile storage apparatus, comprising:
a storage unit that stores data and an error correcting code corresponding to the data;
a read unit that reads the data and the error correcting code corresponding to the data from the storage unit; and
a control unit that controls initialization of the storage unit in response to receipt of an initialization instruction from a host system, the control unit comprising:
a register unit that stores inversion bit information indicating
locations of a plurality of bits to be inverted in data readout process, the plurality of bits to be inverted in data readout process being part of bits of at least one of read data that is read from the storage unit and an error correcting code corresponding to the read data, and
an inversion unit that inverts part of bits of at least one of the read data or the error correcting code corresponding to the read data on the basis of the inversion bit information in the data readout process after the receipt of the initialization instruction.

9. The nonvolatile storage apparatus according to claim 8,
wherein the inversion bit information further indicates a plurality of bits to be inverted in data writing process, the plurality of bits to be inverted in data writing process being part of bits of at least one of write data that is to be written to the storage unit and an error correcting code corresponding to the write data, and
the inversion unit inverts part of bits of at least one of the write data and an error correcting code corresponding to the write data on the basis of the inversion bit information in the data writing process after the initialization of data is performed.

10. The nonvolatile storage apparatus according to claim 8,
wherein the inversion bit information includes a plurality of inversion bit information pieces and a plurality of flags each corresponding to one of the plurality of inversion bit information pieces, the flag indicating whether the corresponding inversion bit information piece is valid or not, and,
the inversion unit inverts the part of bits of the first data or the first error correcting code on the basis of the inversion bit information piece in which the corresponding flag indicates the inversion bit information piece is valid.

11. The nonvolatile storage apparatus according to claim 8, further comprising:
an error determination unit that detects whether there is a data error in the read data on the basis of the read data and the inverted error correcting code corresponding to the read data.

12. The nonvolatile storage apparatus according to claim 8, further comprising:
an error determination unit that determines whether there is a data error in the inverted read data on the basis of the inverted read data and the error correcting code corresponding to the read data.

13. The nonvolatile storage apparatus according to claim 8, further comprising:
an error determination unit that determines whether there is a data error in the read data on the basis of the inverted read data and the error correcting code corresponding to the read data.

14. The nonvolatile storage apparatus according to claim 8,
wherein the number of the plurality of bits to be inverted is more than a number of bits correctable by the error correcting code corresponding to the read data.

15. A method for initializing data stored in a storage medium in response to receipt of an initialization instruction from a host system, the method comprising:
receiving the initialization instruction from the host system;
reading the data and an error correcting code corresponding to the data from the storage medium in data readout process; and
inverting, by a control unit, part of bits of at least one of the read data and the error correcting code corresponding to the read data on the basis of inversion bit information in the data readout process after the receiving the initialization instruction, the inversion bit information indicating a plurality of bits to be inverted in the data readout process, the plurality of bits to be inverted in the data readout process being part of bits of at least one of the read data and the error correcting code corresponding to the read data.

16. The method according to claim 15, the method further comprising:
inverting part of bits of at least one of write data to be written to the storage medium and an error correcting code corresponding to the write data on the basis of the inversion bit information in data writing process after the initializing data is performed, the inversion bit information further indicating a plurality of bits to be inverted in the data writing process, the plurality of bits to be inverted in the data writing process being part of bits of at least one of the write data and the error correcting code corresponding to the write data.
